(19) United States
(12) Patent Application Publication
(10) Pub. No.: US 2008/0218455 A1
(43) Pub. Date: Sep. 11, 2008

(54) Organic electroluminescence display

(75) Inventors: Tetsuro Yamamoto, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/071,637

(22) Filed: Feb. 25, 2008

(30) Foreign Application Priority Data
Mar. 8, 2007 (JP) 2007-058885

(51) Int. Cl. G09G 3/30

(52) U.S. Cl. 345/76

(57) ABSTRACT

The present invention is to provide an organic electroluminescence display including a plurality of pixels, each pixel being composed of a plurality of sub-pixels, each of the sub-pixels having: an organic electroluminescence element configured to have a structure arising from stacking a drive circuit and an organic electroluminescence light-emitting part connected to the drive circuit; wherein to the drive circuit of one sub-pixel of the plurality of sub-pixels included in one pixel, an auxiliary capacitor connected in parallel to the organic electroluminescence light-emitting part of the drive circuit is connected, and the auxiliary capacitor is provided in the same plane as that of the drive circuit.

### CROSS REFERENCES TO RELATED APPLICATIONS

The present invention contains subject matter related to Japanese Patent Application JP 2007-058885 filed in the Japan Patent Office on Mar. 8, 2007, the entire contents of which being incorporated herein by reference.

### BACKGROUND OF THE INVENTION

1. Field of the Invention

The present invention relates to an organic electroluminescence display.

2. Description of the Related Art

In an organic electroluminescence display (hereinafter, abbreviated as an organic EL display) employing an organic electroluminescence element (hereinafter, abbreviated as an organic EL element) as its light-emitting element, the luminance of the organic EL element is controlled based on the current that flows through the organic EL element. Similar to a liquid crystal display, a simple-matrix system and an active-matrix system are known as the driving system of the organic EL display. The active-matrix system has various advantages that it can provide higher image luminance, and so on, although it has a disadvantage that its structure is more complex compared with the simple-matrix system.

As a circuit for driving an organic electroluminescence light-emitting part (hereinafter, abbreviated as a light-emitting part) of an organic EL element, a drive circuit composed of five transistors and one capacitor (hereinafter, referred to as a 5Tr/1C drive circuit) is known due to e.g. Japanese Patent Laid-Open No. 2006-215213. As shown in FIG. 3, the related-art 5Tr/1C drive circuit includes five transistors of a video signal write transistor T_{Sig}, a drive transistor T_{Drv}, a light-emission control transistor T_{EL}_{_{—}}_{C}, a first-node initialization transistor T_{ND1}, and a second-node initialization transistor T_{ND2}. Furthermore, this circuit includes one capacitor C₁. A source/drain region of the drive transistor T_{Drv} is equivalent to a second node ND₂ and the gate electrode of the drive transistor T_{Drv} is equivalent to a first node ND₁.

Details of these transistors and capacitor will be described later.

As shown in the timing chart of FIG. 5, in [period-TP(5)₁], preprocessing for execution of threshold voltage cancel processing is executed. Specifically, the first-node initialization transistor T_{ND1} and the second-node initialization transistor T_{ND2} are turned to the on-state. Thereby, the potential of the first node ND₁ becomes V_{Ofs} (e.g. 0 volt), and the potential of the second node ND₂ becomes V_{SS} (e.g. −10 volts). Thus, the potential difference between the gate electrode and the source/drain region (hereinafter, referred to as the source region, for convenience) of the drive transistor T_{Drv} becomes equal to or larger than Vₜₕ, so that the drive transistor T_{Drv} enters the on-state.

Subsequently, in [period-TP(5)₂], the threshold voltage cancel processing is executed. Specifically, the light-emission control transistor T_{EL}_{_{—}}_{C} is turned to the on-state, with the first-node initialization transistor T_{ND1} kept at the on-state. As a result, the potential of the second node ND₂ in the floating state rises, so that the potential difference between the first and second nodes approaches the threshold voltage of the drive transistor. When the potential difference between the gate electrode and source region of the drive transistor T_{Drv} has reached Vₜₕ, the drive transistor T_{Drv} is turned to the off-state. In this state, the potential of the second node is substantially (V_{Ofs}−Vₜₕ). Thereafter, in [period-TP(5)₃], the light-emission control transistor T_{EL}_{_{—}}_{C} is turned to the off-state, with the first-node initialization transistor T_{ND1} kept at the on-state. Subsequently, in [period-TP(5)₄], the first-node initialization transistor T_{ND1} is turned to the off-state.

Subsequently, in [period-TP(5)₅], a kind of write operation for the drive transistor T_{Drv} is executed. Specifically, in the state in which the first-node initialization transistor T_{ND1}, the second-node initialization transistor T_{ND2}, and the light-emission control transistor T_{EL}_{_{—}}_{C} are kept at the off-state, the potential of a data line DTL is set to a voltage corresponding to a video signal (drive signal (luminance signal) V_{Sig} for controlling the luminance of a light-emitting part ELP), and then a scan line SCL is switched to the high level to thereby turn the video signal write transistor T_{Sig} to the on-state. As a result, the potential of the first node ND₁ rises up to V_{Sig}. If the potential of the second node hardly changes, the potential difference V_{gs} between the gate electrode and the source region of the drive transistor T_{Drv} is represented by Equation (A).

V_{gs}≈V_{Sig}−(V_{Ofs}−Vₜₕ) (A)

Thereafter, in [period-TP(5)₆], correction of the potential of the source region of the drive transistor T_{Drv} (second node ND₂) based on the magnitude of the mobility μ of the drive transistor T_{Drv} (mobility correction processing) is carried out. Specifically, the light-emission control transistor T_{EL}_{_{—}}_{C} is turned to the on-state with the drive transistor T_{Drv} kept at the on-state. Subsequently, after the elapse of a predetermined time (t₀), the video signal write transistor T_{Sig} is turned to the off-state to thereby switch the first node ND₁ (the gate electrode of the drive transistor T_{Drv}) to the floating state. As a result, when the mobility μ of the drive transistor T_{Drv} is high, the rise amount ΔV of the potential (potential correction value) of the source region of the drive transistor T_{Drv} is large. In contrast, when the mobility μ of the drive transistor T_{Drv} is low, the rise amount ΔV of the potential (potential correction value) of the source region of the drive transistor T_{Drv} is small. The potential difference V_{gs} between the gate electrode and source region of the drive transistor T_{Drv}, originally represented by Equation (A), is modified to the potential difference V_{gs} represented by Equation (B). The predetermined time (the total time t₀ of [period-TP(5)₆]) for executing the mobility correction processing is determined as a design value in advance at the time of the designing of the organic EL display.

V_{gs}≈V_{Sig}−(V_{Ofs}−Vₜₕ)−ΔV (B)

Through the above-described operation, the threshold voltage cancel processing, the write processing, and the mobility correction processing are completed. In the subsequent [period-TP(5)₇], the video signal write transistor T_{Sig} is kept at the off-state, and therefore, the first node ND₁, i.e., the gate electrode of the drive transistor T_{Drv}, is in the floating state. In contrast, the light-emission control transistor T_{EL}_{_{—}}_{C} is kept at the on-state, and one source/drain region (hereinafter, referred to as the drain region, for convenience) of the light-emission control transistor T_{EL}_{_{—}}_{C} is connected to a current supply unit (voltage V_{CC}, e.g. 20 volts) for controlling the light emission of the light-emitting part ELP. Consequently, the potential of the second node ND₂ rises, and the same phenomenon as that in a so-called bootstrap circuit occurs at the gate electrode of the drive transistor T_{Drv}, so that the potential of the first node ND₁ also rises up. As a result, the value of Equation (B) is kept as the potential difference V_{gs} between the gate electrode and source region of the drive transistor T_{Drv}. Furthermore, the current that flows through the light-emitting part ELP is a drain current I_{ds} that flows from one source/drain region (hereinafter, referred to as the drain region, for convenience) of the drive transistor T_{Drv} to the source region thereof. Therefore, the current can be represented by Equation (C).

$$\begin{matrix}{I}_{ds} = k \cdot μ \cdot {( {V}_{gs} - {V}_{th} )}^{2} \\ = k \cdot μ \cdot {( {V}_{Sig} - {V}_{Ofs} - Δ V )}^{2}\end{matrix} \qquad ( C )$$

Details of the driving and so on of the 5Tr/1C drive circuit, whose outline has been described above, will also be described later.

### SUMMARY OF THE INVENTION

A discussion will be made below about the respective correction operations. In the preprocessing previous to the threshold voltage cancel processing, the voltage V_{SS} applied to the source region of the drive transistor T_{Drv} is constant. In contrast, in the mobility correction processing, the voltage between the gate electrode and source region of the drive transistor T_{Drv} depends on the drive signal (luminance signal) V_{Sig} and therefore is not constant, as is apparent also from Equation (B). In the mobility correction processing, the potential of the anode electrode of the light-emitting part ELP (the potential of the source region of the drive transistor T_{Drv}), which is being subjected to the mobility correction processing, needs to be lower than the threshold voltage V_{th-EL} necessary for the light emission of the light-emitting part ELP. When the luminance of the organic EL element is designed to be high, a large current flows through the drive transistor T_{Drv}. Therefore, lower capacitance c_{EL} of a parasitic capacitor C_{EL} of the light-emitting part ELP leads to higher speed of the rising of the potential of the source region of the drive transistor T_{Drv}. Consequently, the lower the capacitance c_{EL} of the parasitic capacitor C_{EL} of the light-emitting part ELP is, the shorter the execution time of the mobility correction processing needs to be, and hence, the control of the time of the mobility correction processing is more difficult. Furthermore, when there is large relative variation in the capacitance c_{EL} of the parasitic capacitor C_{EL} of the light-emitting part ELP, a large variation will possibly arise in the rise amount ΔV of the potential (potential correction value) of the source region of the drive transistor T_{Drv}.

In addition, along with increase in the size of organic electroluminescence displays, the current that should be applied to the light-emitting part ELP is also becoming larger. Due to this current increase, the difference in the capacitance of the parasitic capacitor among three sub-pixels (e.g., a red light-emitting sub-pixel, a green light-emitting sub-pixel, and a blue light-emitting sub-pixel) included in one pixel is problematically becomes significantly obvious. To address this problem, a method would be available in which the area of the light-emitting part ELP is adjusted to decrease the difference in the capacitance of the parasitic capacitor of the light-emitting part ELP. However, this method involves a problem that the current density of the current flowing through the light-emitting part ELP in a small-area sub-pixel is large and thus the lifetime of this light-emitting part ELP is shortened.

There is a need for the present invention to provide an organic electroluminescence display having a structure that allows facilitation of control of the execution time of mobility correction processing, and a structure that hardly causes a problem even when there is large relative variation in the capacitance of the parasitic capacitor of an organic electroluminescence light-emitting part and can decrease the difference in the parasitic capacitance among plural sub-pixels included in one pixel.

According to a first mode of the present invention, there is provided an organic electroluminescence display including a plurality of pixels. In the display, each pixel is composed of a plurality of sub-pixels, and each of the sub-pixels includes an organic electroluminescence element configured to have a structure arising from stacking a drive circuit and an organic electroluminescence light-emitting part connected to the drive circuit. To the drive circuit of one sub-pixel of the plurality of sub-pixels included in one pixel, an auxiliary capacitor connected in parallel to the organic electroluminescence light-emitting part of the drive circuit is connected. The auxiliary capacitor is provided in the same plane as that of the drive circuit.

In the organic electroluminescence display according to the first mode of the present invention, in the plurality of sub-pixels included in one pixel, the sizes of the drive circuits of these plural sub-pixels may be identical to each other. However, the organic electroluminescence display according to the first mode is not limited to such a configuration, but another configuration is also available. Specifically, in this configuration, to each of at least two of the drive circuits of the plurality of sub-pixels included in one pixel, an auxiliary capacitor connected in parallel to the organic electroluminescence light-emitting part of the drive circuit is connected. Furthermore, these auxiliary capacitors are provided in the same plane as that of the drive circuits, and the capacitances of these auxiliary capacitors are identical to or different from each other.

According to a second mode of the present invention, there is provided another organic electroluminescence display including a plurality of pixels. Also in this display, each pixel is composed of a plurality of sub-pixels, and each of the sub-pixels includes an organic electroluminescence element configured to have a structure arising from stacking a drive circuit and an organic electroluminescence light-emitting part connected to the drive circuit. In this display, in the plurality of sub-pixels included in one pixel, the size of one drive circuit of the drive circuits of the plurality of sub-pixels is larger than those of the other drive circuits. This one drive circuit is provided with an auxiliary capacitor connected in parallel to the organic electroluminescence light-emitting part of the drive circuit.

The organic electroluminescence display according to the second mode of the present invention may employ another configuration. Specifically, in this configuration, each of at least two of the drive circuits of the plurality of sub-pixels included in one pixel is provided with an auxiliary capacitor connected in parallel to the organic electroluminescence light-emitting part of the drive circuit. Furthermore, the capacitances of these auxiliary capacitors are identical to or different from each other.

In the organic electroluminescence displays according to the first mode and second mode of the present invention (hereinafter, these displays will be referred to simply as the organic EL displays of the present invention or the present invention collectively) including the above-described preferred configuration, the kind of sub-pixel including the drive circuit to which the auxiliary capacitor is connected or the kind of sub-pixel including the drive circuit provided with the auxiliary capacitor depends mainly on the capacitance of the parasitic capacitor of the organic electroluminescence light-emitting part. Furthermore, the capacitance of the parasitic capacitor of the organic electroluminescence light-emitting part depends greatly on the material of the light-emitting layer of the organic electroluminescence light-emitting part. For the organic electroluminescence display according to the first mode of the present invention, when the capacitance of the parasitic capacitor of the organic electroluminescence light-emitting part of the drive circuit included in one sub-pixel is defined as c_{EL} and the capacitance of the auxiliary capacitor connected to this drive circuit is defined as c_{Sub}, it is desirable that the relationship c_{Sub}≧0.2c_{EL}, preferably c_{Sub}≧0.4c_{EL}, be satisfied, for example. Furthermore, for the organic electroluminescence display according to the second mode of the present invention, when the size of one drive circuit is defined as S₁ and the size of the other drive circuits is defined as S₂, it is desirable that the relationship S₁≧1.2S₂, preferably S₁≧1.3S₂, be satisfied, for example. Moreover, for one drive circuit in the organic electroluminescence display according to the second mode of the present invention, when the capacitance of the parasitic capacitor of the organic electroluminescence light-emitting part is defined as c_{EL} and the capacitance of the auxiliary capacitor is defined as c_{Sub}, it is desirable that the relationship c_{Sub}≧0.2c_{EL}, preferably c_{Sub}≧0.4c_{EL}, be satisfied, for example.

In the organic EL displays of the present invention including the above-described preferred configuration, the drive circuit may include:

(A) a drive transistor having source/drain regions, a channel forming region, and a gate electrode;

(B) a video signal write transistor having source/drain regions, a channel forming region, and a gate electrode; and

(C) a capacitor having a pair of electrodes. Furthermore, the drive circuit may have the following configuration.

Specifically, regarding the drive transistor,

(A-1) one source/drain region of the drive transistor is connected to a current supply unit,

(A-2) the other source/drain region of the drive transistor is connected to an anode electrode of the organic electroluminescence light-emitting part and one electrode of the capacitor, and is equivalent to a second node, and

(A-3) the gate electrode of the drive transistor is connected to the other source/drain region of the video signal write transistor and the other electrode of the capacitor, and is equivalent to a first node, and

regarding the video signal write transistor,

(B-1) one source/drain region of the video signal write transistor is connected to a data line, and

(B-2) the gate electrode of the video signal write transistor is connected to a scan line.

The organic EL displays of the present invention may include:

(a) a scan circuit;

(b) a video signal output circuit;

(c) organic electroluminescence elements that are arranged in a two-dimensional matrix of N×M in which N elements are arranged along a first direction and M elements are arranged along a second direction different from the first direction;

(d) M scan lines that are connected to the scan circuit and extend along the first direction;

(e) N data lines that are connected to the video signal output circuit and extend along the second direction; and

(f) a current supply unit.

In the present invention, each pixel is composed of plural sub-pixels. Specifically, a form can be employed in which each pixel is composed of three sub-pixels of a red light-emitting sub-pixel, a green light-emitting sub-pixel, and a blue light-emitting sub-pixel. Alternatively, it is also possible that each pixel be composed of a sub-pixel group obtained by further adding one kind or plural kinds of sub-pixels to these three kinds of sub-pixels (e.g., a group obtained by adding a sub-pixel that emits white light for an enhanced luminance, a group obtained by adding a sub-pixel that emits complementary-color light for an enlarged color gamut, a group obtained by adding a sub-pixel that emits yellow light for an enlarged color gamut, or a group obtained by adding sub-pixels that emit yellow light and cyan light for an enlarged color gamut).

For the organic EL displays of the present invention, known configurations and structures can be employed as the configurations and structures of the scan circuit, video signal output circuit, scan lines, data lines, current supply unit, and organic electroluminescence light-emitting part (hereinafter, it will be often referred to simply as a light-emitting part). Specifically, the light-emitting part can be formed by using e.g. an anode electrode, hole transport layer, light-emitting layer, electron transport layer, and cathode electrode.

The drive circuit, whose details will be described later, may be formed of a drive circuit composed of five transistors and one capacitor (5Tr/1C drive circuit), drive circuit composed of four transistors and one capacitor (4Tr/1C drive circuit), drive circuit composed of three transistors and one capacitor (3Tr/1C drive circuit), or drive circuit composed of two transistors and one capacitor (2Tr/1C drive circuit).

As transistors included in the drive circuit, an n-channel thin film transistor (TFT) is available. However, depending on the case, it is also possible to employ a p-channel thin film transistor for a light-emission control transistor, for example. Alternatively, it is also possible that the transistors be formed of field effect transistors (e.g. MOS transistors) formed on a silicon semiconductor substrate. The auxiliary capacitor can be formed from one electrode, the other electrode, and a dielectric layer (insulating layer) interposed between these electrodes. The capacitor can also be formed from one electrode, the other electrode, and a dielectric layer (insulating layer) interposed between these electrodes. The transistors and the capacitor of the drive circuit and the auxiliary capacitor are formed in a certain plane (for example, formed on a support body). The light-emitting part is formed above the transistors and the capacitor of the drive circuit and the auxiliary capacitor with the intermediary of an interlayer insulating layer, for example. The other source/drain region of the drive transistor is connected via e.g. a contact hole to the anode electrode of the light-emitting part. Furthermore, one electrode of the auxiliary capacitor is also connected to the other source/drain region of the drive transistor.

In the present invention, the auxiliary capacitor is connected to the source region of the drive transistor (second node). This can decrease the rising speed of the potential of the source region of the drive transistor (second node) in mobility correction processing, and thus can extend the execution time of the mobility correction processing. This results in facilitation of control of the time of the mobility correction processing. Furthermore, variation in the capacitance of the parasitic capacitor of the light-emitting part can be reduced relatively, which can prevent the occurrence of a large variation in the rise amount ΔV of the potential (potential correction value) of the source region of the drive transistor. Moreover, due to the present invention, the rising speed of the potential of the source region of the drive transistor (second node) can be decreased, and therefore, a high reverse-bias voltage does not need to be applied to the organic electroluminescence light-emitting part. This allows suppression of the number of dot defects to a small value. In addition, the size of the organic electroluminescence light-emitting part does not need to be changed. This allows reduction in the current density of the current that flows through the organic electroluminescence light-emitting part, and thus can realize the extension of the lifetime of the organic electroluminescence element.

### BRIEF DESCRIPTION OF THE DRAWINGS

FIG. 1A is a conceptual diagram (plan view) of a plane occupied by one pixel (plural sub-pixels) in an organic electroluminescence display according to a first embodiment of the present invention;

FIG. 1B is a conceptual diagram (plan view) of a plane occupied by plural drive circuits and one auxiliary capacitor in the organic electroluminescence display;

FIG. 1C is a conceptual diagram (plan view) of a plane occupied by one pixel (plural sub-pixels) in an organic electroluminescence display according to a second embodiment of the present invention;

FIG. 2 is an equivalent circuit diagram of a drive circuit that is basically composed of five transistors/one capacitor (and is provided with an auxiliary capacitor);

FIG. 3 is an equivalent circuit diagram of a drive circuit that is basically composed of five transistors/one capacitor (and is not provided with an auxiliary capacitor);

FIG. 4 is a conceptual diagram of a display including the drive circuits basically composed of five transistors/one capacitor;

FIG. 5 is a diagram schematically showing a timing chart regarding the driving of the drive circuit basically composed of five transistors/one capacitor;

FIGS. 6A to 6I are diagrams schematically showing the on/off-states of the respective transistors and so on in the drive circuit basically composed of five transistors/one capacitor;

FIG. 7 is an equivalent circuit diagram of a drive circuit that is basically composed of four transistors/one capacitor (and is provided with an auxiliary capacitor);

FIG. 8 is an equivalent circuit diagram of a drive circuit that is basically composed of four transistors/one capacitor (and is not provided with an auxiliary capacitor);

FIG. 9 is a conceptual diagram of a display including the drive circuits basically composed of four transistors/one capacitor;

FIG. 10 is a diagram schematically showing a timing chart regarding the driving of the drive circuit basically composed of four transistors/one capacitor;

FIGS. 11A to 11H are diagrams schematically showing the on/off-states of the respective transistors and so on in the drive circuit basically composed of four transistors/one capacitor;

FIG. 12 is an equivalent circuit diagram of a drive circuit that is basically composed of three transistors/one capacitor (and is provided with an auxiliary capacitor);

FIG. 13 is an equivalent circuit diagram of a drive circuit that is basically composed of three transistors/one capacitor (and is not provided with an auxiliary capacitor);

FIG. 14 is a conceptual diagram of a display including the drive circuits basically composed of three transistors/one capacitor;

FIG. 15 is a diagram schematically showing a timing chart regarding the driving of the drive circuit basically composed of three transistors/one capacitor;

FIGS. 16A to 16I are diagrams schematically showing the on/off-states of the respective transistors and so on in the drive circuit basically composed of three transistors/one capacitor;

FIG. 17 is an equivalent circuit diagram of a drive circuit that is basically composed of two transistors/one capacitor (and is provided with an auxiliary capacitor);

FIG. 18 is an equivalent circuit diagram of a drive circuit that is basically composed of two transistors/one capacitor (and is not provided with an auxiliary capacitor);

FIG. 19 is a conceptual diagram of a display including the drive circuits basically composed of two transistors/one capacitor;

FIG. 20 is a diagram schematically showing a timing chart regarding the driving of the drive circuit basically composed of two transistors/one capacitor;

FIGS. 21A to 21F are diagrams schematically showing the on/off-states of the respective transistors and so on in the drive circuit basically composed of two transistors/one capacitor;

FIG. 22 is a diagram schematically showing a timing chart, different from that shown in FIG. 20, regarding the driving of the drive circuit basically composed of two transistors/one capacitor; and

FIG. 23 is a schematic partial sectional view of a partial portion of an organic electroluminescence element.

### DETAILED DESCRIPTION OF THE PREFERRED EMBODIMENTS

Embodiments of the present invention will be described below with reference to the accompanying drawings.

### First Embodiment

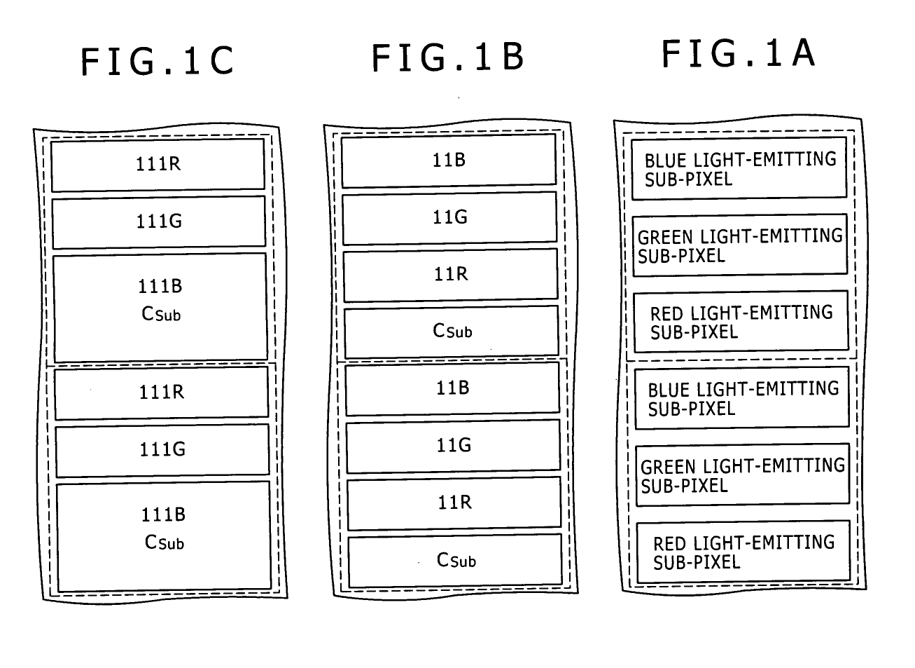

A first embodiment of the present invention relates to an organic EL display according to the first mode of the present invention. FIG. 1A is a conceptual diagram (plan view) of a plane occupied by one pixel. FIG. 1B is a conceptual diagram (plan view) of a plane occupied by three drive circuits and one auxiliary capacitor C_{Sub}. One pixel is surrounded by a dashed line, and each of the sub-pixels, drive circuits, and auxiliary capacitors is surrounded by a full line. Two pixels are indicated in each of FIGS. 1A, 1B, and 1C.

Organic EL displays of the first embodiment and a second embodiment of the present invention, which will be described later, include plural pixels. Furthermore, each pixel is composed of plural sub-pixels (in the first embodiment and the second embodiment to be described later, three sub-pixels of a red light-emitting sub-pixel, a green light-emitting sub-pixel, and a blue light-emitting sub-pixel). Each of the sub-pixels is formed of an organic electroluminescence element (organic EL element 10) that has a structure arising from stacking a drive circuit 11 and an organic electroluminescence light-emitting part (light-emitting part ELP) connected to this drive circuit 11. The drive circuit of a red light-emitting sub-pixel is indicated by reference numeral 11R, the drive circuit of a green light-emitting sub-pixel is indicated by reference numeral 11G, and the drive circuit of a blue light-emitting sub-pixel is indicated by reference numeral 11B.

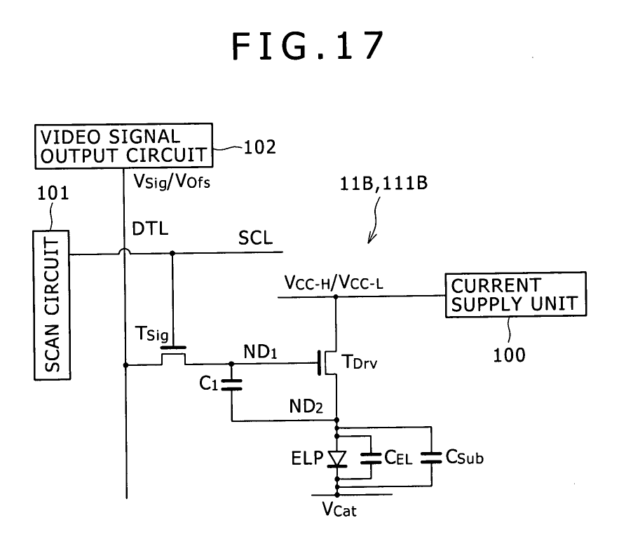

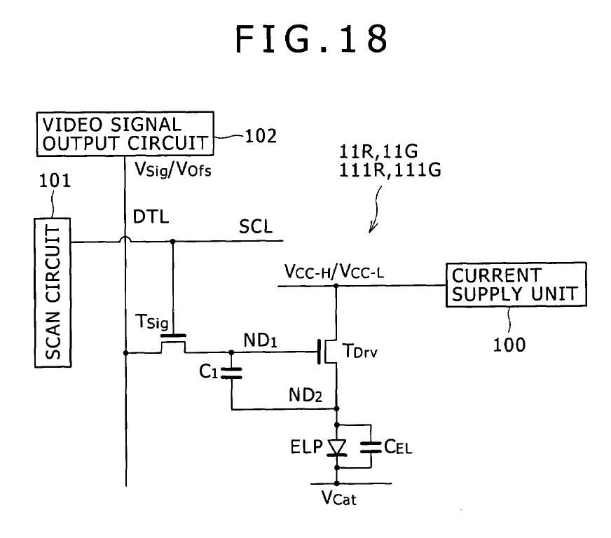

In the organic EL display of the first embodiment, as shown in the equivalent circuit diagram of FIG. 17, the auxiliary capacitor C_{Sub} connected in parallel to the light-emitting part ELP of the drive circuit 11B is connected to the drive circuit 11B of one sub-pixel (e.g. a blue light-emitting sub-pixel) of the plural sub-pixels included in one pixel. This auxiliary capacitor C_{Sub} is provided in the same plane as that of the drive circuit. As shown in the equivalent circuit diagram of FIG. 18, the auxiliary capacitor C_{Sub} is not connected to the drive circuits 11R and 11G of the other sub-pixels (e.g. red and green light-emitting sub-pixels). The color of the sub-pixel having the drive circuit connected to the auxiliary capacitor C_{Sub} depends mainly on the capacitance c_{EL} of the parasitic capacitor C_{EL} of the light-emitting part ELP. Furthermore, the capacitance c_{EL} of the parasitic capacitor C_{EL} of the light-emitting part ELP depends greatly on the material of the light-emitting layer of the light-emitting part ELP.

In the first embodiment, in the plural sub-pixels of one pixel, the sizes of the drive circuits 11R, 11G, and 11B in these plural sub-pixels are set identical to each other. More specifically, the total area occupied by the light-emitting parts ELP in one pixel (three sub-pixels) is substantially equal to the total area occupied by three drive circuits 11R, 11G, and 11B and one auxiliary capacitor C_{Sub}. Furthermore, for example, the area occupied by each of the drive circuits 11R, 11G, and 11B is substantially equal to the area occupied by one auxiliary capacitor C_{Sub}. Moreover, the areas occupied by the respective light-emitting parts ELP of three sub-pixels are substantially equal to each other. When the capacitance of the parasitic capacitor of the light-emitting part ELP of the drive circuit 11B in one sub-pixel is defined as c_{EL} and the capacitance of the auxiliary capacitor connected to this drive circuit 11B is defined as c_{Sub}, the relationship c_{Sub}≈0.4c_{EL} is satisfied.

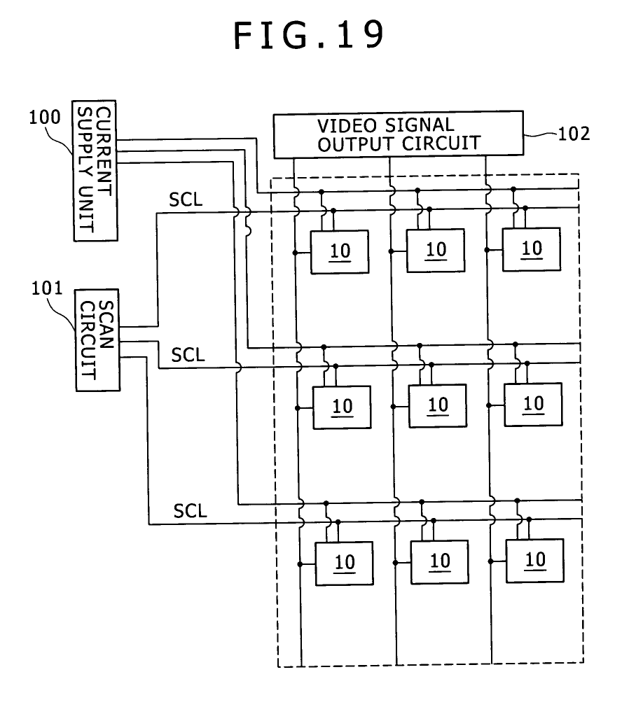

As shown in the conceptual circuit diagram of FIG. 19, the organic EL display of the first embodiment and an organic EL display of the second embodiment to be described later include

(a) a scan circuit 101,

(b) a video signal output circuit 102,

(c) organic EL elements 10 that are arranged in a two-dimensional matrix of N×M in which N elements are arranged along a first direction and M elements are arranged along a second direction different from the first direction (specifically, the direction perpendicular to the first direction),

(d) M scan lines SCL that are connected to the scan circuit 101 and extend along the first direction,

(e) N data lines DTL that are connected to the video signal output circuit 102 and extend along the second direction, and

(f) a current supply unit 100.

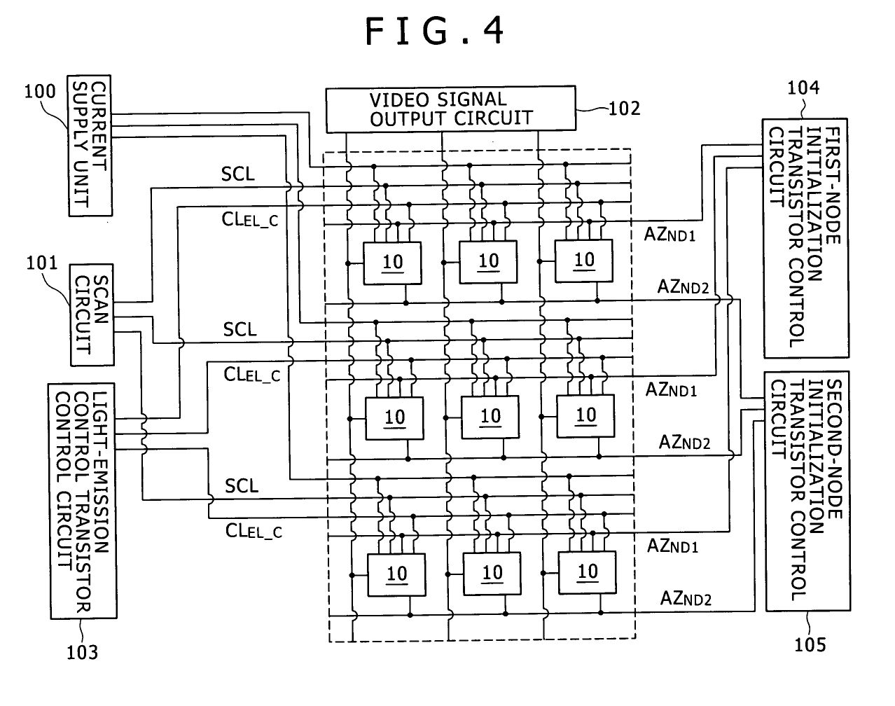

In FIG. 19 and FIGS. 4, 9, and 14 to be described later, 3×3 organic EL elements 10 are shown. However, this is merely an example.

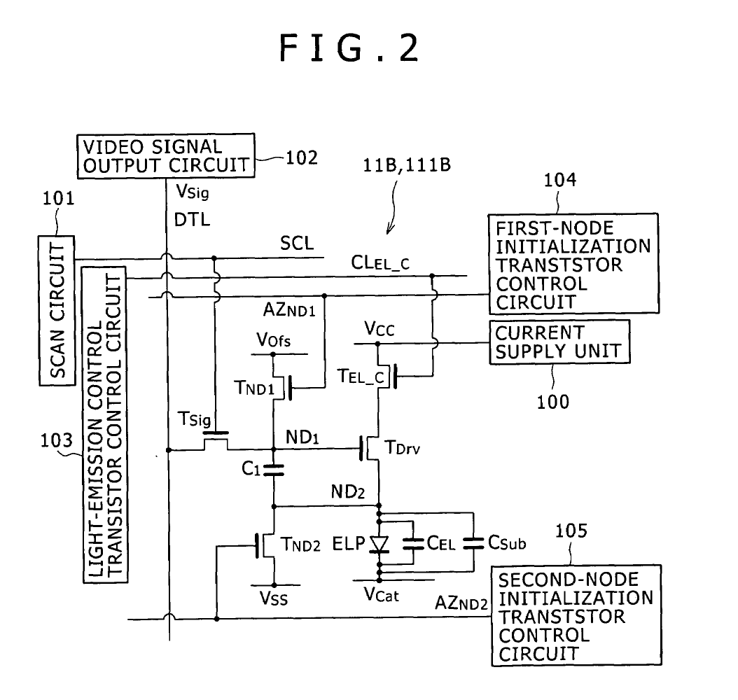

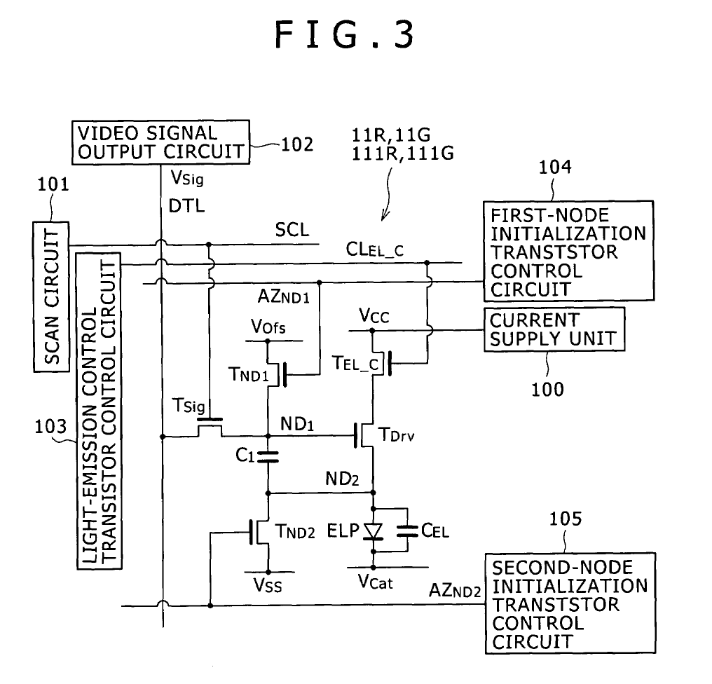

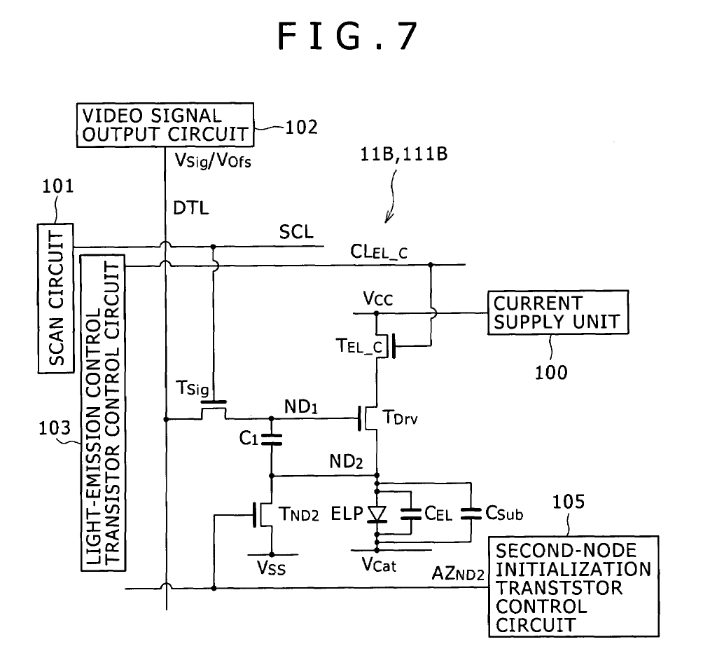

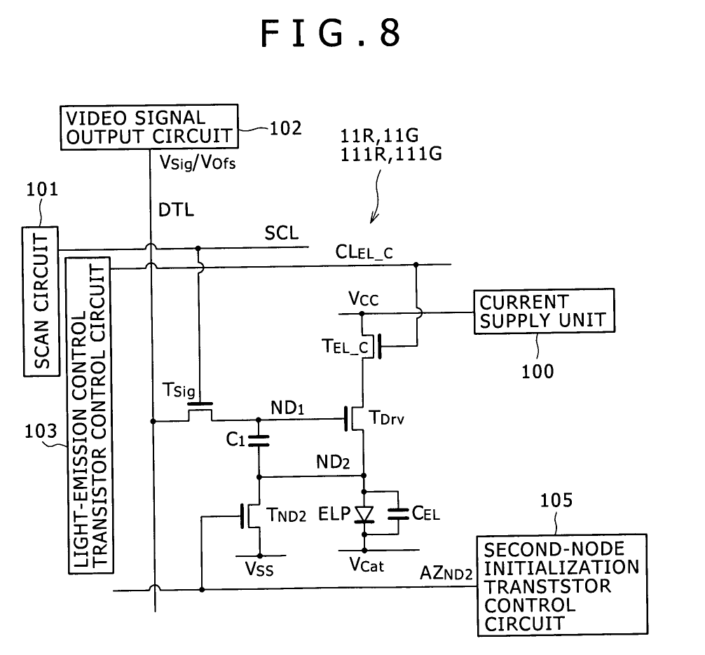

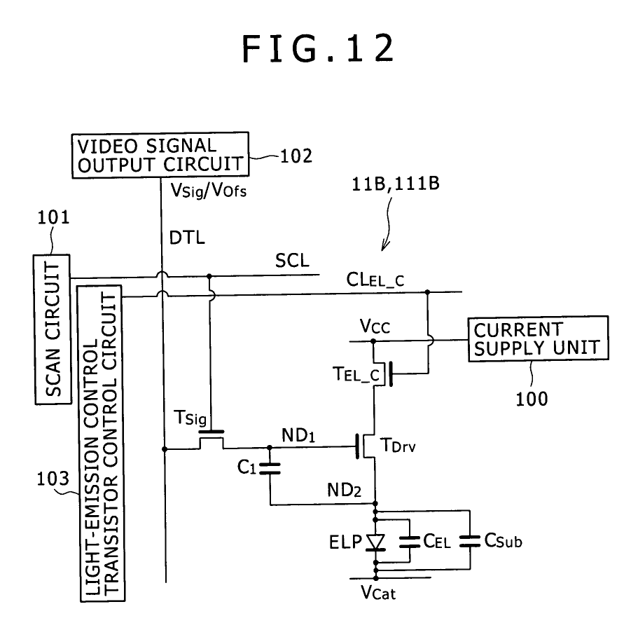

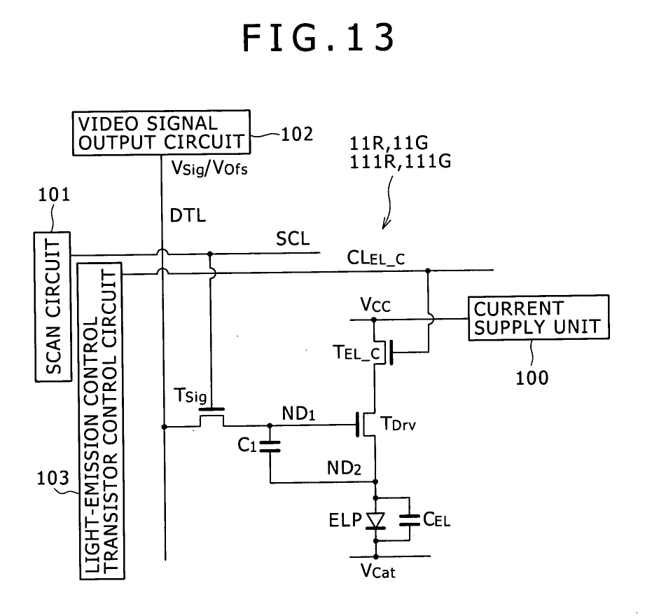

The auxiliary capacitor C_{Sub} as a feature of the first embodiment and the second embodiment to be described later can be applied not only to a drive circuit basically composed of two transistors/one capacitor but also to a drive circuit basically composed of five transistors/one capacitor, a drive circuit basically composed of four transistors/one capacitor, and a drive circuit basically composed of three transistors/one capacitor. Equivalent circuit diagrams of a drive circuit basically composed of five transistors/one capacitor according to the first embodiment and the second embodiment to be described later are shown in FIG. 2 (relating to the drive circuits 11B and 111B) and FIG. 3 (relating to the drive circuits 11R, 11G, 111R, and 111G). Equivalent circuit diagrams of a drive circuit basically composed of four transistors/one capacitor according to the first and second embodiments are shown in FIG. 7 (relating to the drive circuits 11B and 111B) and FIG. 8 (relating to the drive circuits 11R, 11G, 111R, and 111G). Equivalent circuit diagrams of a drive circuit basically composed of three transistors/one capacitor according to the first and second embodiments are shown in FIG. 12 (relating to the drive circuits 11B and 111B) and FIG. 13 (relating to the drive circuits 11R, 11G, 111R, and 111G). Equivalent circuit diagrams of a drive circuit basically composed of two transistors/one capacitor according to the first and second embodiments are shown in FIG. 17 (relating to the drive circuits 11B and 111B) and FIG. 18 (relating to the drive circuits 11R, 11G, 111R, and 111G).

The light-emitting part ELP has a known configuration and structure including e.g. an anode electrode, a hole transport layer, a light-emitting layer, electron transport layer, and a cathode electrode. The scan circuit 101 is provided near one ends of the scan lines SCL. Known configurations and structures can be used as those of the scan circuit 101, the video signal output circuit 102, the scan lines SCL, the data lines DTL, and the current supply unit 100. This may apply also to an organic EL display according to the second embodiment to be described later.

In the first embodiment and the second embodiment to be described later, a drive circuit composed of two transistors and one capacitor C₁ (2Tr/1C drive circuit) is employed. Specifically, as shown in FIGS. 17 and 18, the drive circuit of the first embodiment is composed of a drive transistor T_{Drv}, a video signal write transistor T_{Sig}, and a capacitor C₁ including a pair of electrodes. The drive transistor T_{Drv} is formed of an n-channel TFT including source/drain regions, a channel forming region, and a gate electrode. The video signal write transistor T_{Sig} is also formed of an n-channel TFT including source/drain regions, a channel forming region, and a gate electrode. Furthermore, as shown in FIG. 17, an auxiliary capacitor C_{Sub} connected to a drive circuit 11B is provided. This auxiliary capacitor C_{Sub} is connected in parallel to the light-emitting part ELP of the drive circuit 11B.

Regarding the drive transistor T_{Drv},

(A-1) one source/drain region (hereinafter, referred to as the drain region) is connected to the current supply unit 100,

(A-2) the other source/drain region (hereinafter, referred to as the source region) is connected to the anode electrode of the light-emitting part ELP and one electrode of the capacitor C₁ and is equivalent to a second node ND₂, and

(A-3) the gate electrode is connected to the other source/drain region of the video signal write transistor T_{Sig} and the other electrode of the capacitor C₁ and is equivalent to a first node ND₁.

Furthermore, regarding the video signal write transistor T_{Sig},

(B-1) one source/drain region is connected to the data line DTL, and

(B-2) the gate electrode is connected to the scan line SCL.

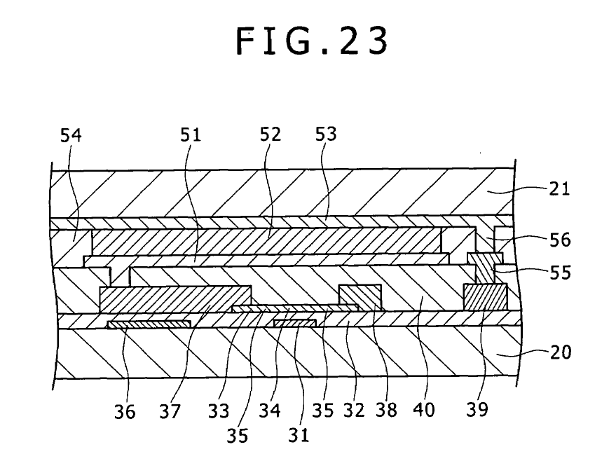

More specifically, as shown in the schematic partial sectional view of FIG. 23 for one partial portion of the organic EL element, the transistors T_{Sig} and T_{Drv} and the capacitor C₁ of the drive circuit are formed over a support body, and the light-emitting part ELP is formed above the transistors T_{Sig} and T_{Drv} and the capacitor C₁ of the drive circuit with the intermediary of an interlayer insulating layer 40, for example. The other source/drain region of the drive transistor T_{Drv} is connected via a contact hole to the anode electrode of the light-emitting part ELP. Note that only the drive transistor T_{Drv} is shown in FIG. 23. The video signal write transistor T_{Sig}, the auxiliary capacitor C_{Sub}, and various transistors in the other drive circuits to be described later are in hiding and hence, are not seen.

More specifically, the drive transistor T_{Drv} is composed of a gate electrode 31, a gate insulating layer 32, source/drain regions 35 provided in a semiconductor layer 33, and a channel forming region 34 formed of the partial portion of the semiconductor layer 33 between the source/drain regions 35. The capacitor C₁ is composed of the other electrode 36, a dielectric layer formed of an extended portion of the gate insulating layer 32, and one electrode 37 (equivalent to the second node ND₂). The gate electrode 31, a partial portion of the gate insulating layer 32, and the other electrode 36 of the capacitor C₁ are formed on the support body 20. One source/drain region 35 of the drive transistor T_{Drv} is connected to an interconnect 38, and the other source/drain region 35 is connected to one electrode 37 (equivalent to the second node ND₂). The drive transistor T_{Drv}, the capacitor C₁, and so on are covered by the interlayer insulating layer 40. Provided on the interlayer insulating layer 40 is the light-emitting part ELP composed of an anode electrode 51, a hole transport layer, a light-emitting layer, an electron transport layer, and a cathode electrode 53. In FIG. 23, the hole transport layer, the light-emitting layer, and the electron transport layer are collectively shown as one layer 52. A second interlayer insulating layer 54 is provided on the partial portion of the interlayer insulating layer 40 on which the light-emitting part ELP is not provided. A transparent substrate 21 is disposed over the second interlayer insulating layer 54 and the cathode electrode 53, and light generated by the light-emitting layer is emitted to the external after passing through the substrate 21. One electrode 37 (second node ND₂) and the anode electrode 51 are connected to each other via a contact hole provided in the interlayer insulating layer 40. The cathode electrode 53 is connected to an interconnect 39 provided on an extended portion of the gate insulating layer 32 via contact holes 56 and 55 provided in the second interlayer insulating layer 54 and the interlayer insulating layer 40.

In the organic EL display of the first embodiment, the auxiliary capacitor C_{Sub} is connected to the source region of the drive transistor T_{Drv} (second node ND₂). This can decrease the rising speed of the potential of the source region of the drive transistor T_{Drv} (second node ND₂) in the mobility correction processing to be described later, and thus can extend the execution time of the mobility correction processing. This results in facilitation of control of the time of the mobility correction processing. Furthermore, variation in the capacitance c_{EL} of the parasitic capacitor C_{EL} of the light-emitting part ELP can be reduced relatively, which can prevent the occurrence of a large variation in the rise amount ΔV of the potential (potential correction value) of the source region of the drive transistor T_{Drv} (second node ND₂). Moreover, the size of the light-emitting part ELP does not need to be changed depending on the kind of sub-pixel. This allows reduction in the current density of the current that flows through the light-emitting part ELP, and thus can realize the extension of the lifetime of the organic EL element.

### Second Embodiment

The second embodiment of the present invention relates to an organic EL display according to the second mode of the present invention. FIG. 1C is a conceptual diagram (plan view) of a plane occupied by one pixel in the second embodiment.

The organic EL display of the second embodiment includes plural pixels. Furthermore, each pixel is composed of plural sub-pixels (also in the second embodiment, three sub-pixels of a red light-emitting sub-pixel, a green light-emitting sub-pixel, and a blue light-emitting sub-pixel). Each of the sub-pixels is formed of an organic electroluminescence element (organic EL element 10) that has a structure arising from stacking a drive circuit 111 and an organic electroluminescence light-emitting part (light-emitting part ELP) connected to this drive circuit 111.

In addition, in the plural sub-pixels included in one pixel, the size of one of the drive circuits of these plural sub-pixels (e.g. a drive circuit 111B of the blue light-emitting sub-pixel) is larger than that of the other drive circuits (e.g. a drive circuit 111R of the red light-emitting sub-pixel and a drive circuit 111G of the green light-emitting sub-pixel), as shown in the equivalent circuit diagram of FIG. 17. This one drive circuit 111B is provided with the auxiliary capacitor C_{Sub} connected in parallel to the light-emitting part ELP of this drive circuit 111B. As shown in the equivalent circuit diagram of FIG. 18, the auxiliary capacitor C_{Sub} is not connected to the drive circuits 111R and 111G of the other sub-pixels (e.g. red and green light-emitting sub-pixels). The color of the sub-pixel having the drive circuit provided with the auxiliary capacitor C_{Sub} depends mainly on the capacitance c_{EL} of the parasitic capacitor C_{EL} of the light-emitting part ELP. Furthermore, the capacitance c_{EL} of the parasitic capacitor C_{EL} of the light-emitting part ELP depends greatly on the material of the light-emitting layer of the light-emitting part ELP. In the second embodiment, when the sizes of the drive circuits 111B, 111R, and 111G of the blue, red, and green light-emitting sub-pixels are defined as S_{B}, S_{R}, and S_{G}, respectively, the relationship S_{B}≈1.2S_{R}≈1.2S_{G} is satisfied. Furthermore, in one drive circuit 111B, when the capacitance of the parasitic capacitor of the light-emitting part ELP is defined as c_{EL} and the capacitance of the auxiliary capacitor C_{Sub} is defined as c_{Sub}, the relationship c_{Sub}≧0.2c_{EL} is satisfied.

The basic configuration and structure of the organic EL display and the drive circuits 111R, 111G, and 111B in the second embodiment can be the same as those of the organic EL display and the drive circuits 11R, 11G, and 11B in the first embodiment, and therefore, the detailed description thereof is omitted.

The configuration of the drive circuits in the first embodiment and that of the drive circuits in the second embodiment may be combined with each other.

In the organic EL display of the second embodiment, in the plural sub-pixels included in one pixel, the size of one of the drive circuits of these plural sub-pixels (e.g. the drive circuit 111B) is larger than that of the other drive circuits (e.g. the drive circuits 111R and 111G). Therefore, in this one drive circuit 111B, the auxiliary capacitor C_{Sub} connected in parallel to the light-emitting part ELP can be easily provided. Furthermore, the auxiliary capacitor C_{Sub} is connected to the source region of the drive transistor T_{Drv} (second node ND₂). This can decrease the rising speed of the potential of the source region of the drive transistor T_{Drv} (second node ND₂) in the mobility correction processing to be described later, and thus can extend the execution time of the mobility correction processing. This results in facilitation of control of the time of the mobility correction processing. In addition, variation in the capacitance c_{EL} of the parasitic capacitor C_{EL} of the light-emitting part ELP can be reduced relatively, which can prevent the occurrence of a large variation in the rise amount ΔV of the potential (potential correction value) of the source region of the drive transistor T_{Drv} (second node ND₂). Moreover, the size of the light-emitting part ELP does not need to be changed depending on the kind of sub-pixel. This allows reduction in the current density of the current that flows through the light-emitting part ELP, and thus can realize the extension of the lifetime of the organic EL element.

A description will be made below about a 5Tr/1C drive circuit, 4Tr/1C drive circuit, 3Tr/1C drive circuit, 2Tr/1C drive circuit, and methods for driving the light-emitting part ELP by using these drive circuits. In the following explanation, description relating to the auxiliary capacitor C_{Sub}, i.e., description of the feature that these drive circuits are provided with or include the auxiliary capacitor C_{Sub}, is omitted.

The organic EL display includes pixels arranged in a two-dimensional matrix of (N/3)×M. In the following description, one pixel is formed of three sub-pixels (a red light-emitting sub-pixel for red light emission, a green light-emitting sub-pixel for green light emission, and a blue light-emitting sub-pixel for blue light emission). The organic EL elements 10 of the respective pixels are line-sequentially driven, and the display frame rate is defined as FR (times/second). Specifically, the organic EL elements 10 of N/3 pixels (N sub-pixels) arranged on the m-th row (m=1, 2, 3 . . . M) are simultaneously driven. In other words, the timings of the light-emission/non-light-emission of the organic EL elements 10 are controlled on a row-by-row basis. The processing of writing video signals to the respective pixels on one row may be either processing in which the video signals are simultaneously written to all of these pixels (hereinafter, it will be often referred to simply as simultaneous-write processing) or processing in which the video signals are sequentially written on a pixel-by-pixel basis (hereinafter, it will be often referred to simply as sequential-write processing). Which write processing to employ is properly selected depending on the drive circuit configuration.

A description will be made below about driving and operation relating to the organic EL element 10 of one sub-pixel in the pixel located on the m-th row and the n-th column (n=1, 2, 3 . . . N) as a rule. This sub-pixel and this organic EL element 10 will be referred to as the (n, m)-th sub-pixel and the (n, m)-th organic EL element 10, respectively. By the time the horizontal scanning period of the organic EL elements 10 arranged on the m-th row (the m-th horizontal scanning period) finishes, various kinds of processing (threshold voltage cancel processing, write processing, and mobility correction processing, which will be described later) are executed. The write processing and the mobility correction processing should be executed within the m-th horizontal scanning period. On the other hand, depending on the kind of drive circuit, the threshold voltage cancel processing and preprocessing for this processing can be executed ahead of the m-th horizontal scanning period.

After all of these various kinds of processing have been completed, the light-emitting parts of the organic EL elements 10 arranged on the m-th row are caused to emit light. The light-emitting parts may be caused to emit light immediately after all of the various kinds of processing have been completed. Alternatively, they may be caused to emit light after the elapse of a predetermined period (e.g. horizontal scanning periods of several predetermined rows). This predetermined period can be properly designed depending on the specification of the organic EL display, the configuration of the drive circuit, and so on. In the following description, the light-emitting part is caused to emit light immediately after the completion of the various kinds of processing, for convenience of explanation. Furthermore, the light emission of the light-emitting parts of the respective organic EL elements 10 arranged on the m-th row is continued until the timing immediately before the start of the horizontal scanning period of the respective organic EL elements 10 arranged on the (m+m′)-th row. This m′ is determined depending on the design specification of the organic EL display. Specifically, the light emission of the light-emitting parts of the organic EL elements 10 arranged on the m-th row in a certain display frame is continued until the end of the (m+m′−1)-th horizontal scanning period. On the other hand, in the period from the start of the (m+m′)-th horizontal scanning period to the completion of the write processing and the mobility correction processing within the m-th horizontal scanning period in the next display frame, the light-emitting parts of the organic EL elements 10 arranged on the m-th are kept at the non-light-emission state. Due to the provision of the period of this non-light-emission state (hereinafter, it will be often referred to simply as the non-light-emission period), image-lag blur accompanying the active-matrix driving is reduced, and thus the moving-image quality can be enhanced. However, the light-emission state/non-light-emission state of the respective sub-pixels (organic EL elements 10) are not limited to the above-described states. The time length of the horizontal scanning period is shorter than (1/FR)×(1/M). If the value of (m+m′) surpasses M, the horizontal scanning period corresponding to the surplus is processed in the next display frame.

For two source/drain regions of one transistor, the term “one source/drain region” is often used to indicate the source/drain region connected to a power supply. Furthermore, the expression “a transistor is in the on-state” refers to the state in which a channel is formed between the source/drain regions of the transistor. This state is irrespective of whether or not a current flows from one source/drain region of the transistor to the other source/drain region thereof. On the other hand, the expression “a transistor is in the off-state” refers to the state in which a channel is not formed between the source/drain regions of the transistor. The expression “a source/drain region of a certain transistor is connected to a source/drain region of another transistor” encompasses a form in which the source/drain region of the certain transistor and the source/drain region of another transistor occupy the same region. Furthermore, the source/drain regions can be formed not only by using an electrically-conductive substance such as poly-silicon or amorphous silicon containing an impurity but also by using a metal, alloy, electrically-conductive particle, multilayer structure of these materials, or layer composed of an organic material (electrically-conductive polymer). In the timing charts used in the following description, the lengths of the abscissa axes (time lengths) representing the respective periods do not indicate the ratio of the time lengths of the respective periods but are schematically shown.

### [5Tr/1C Drive Circuit]

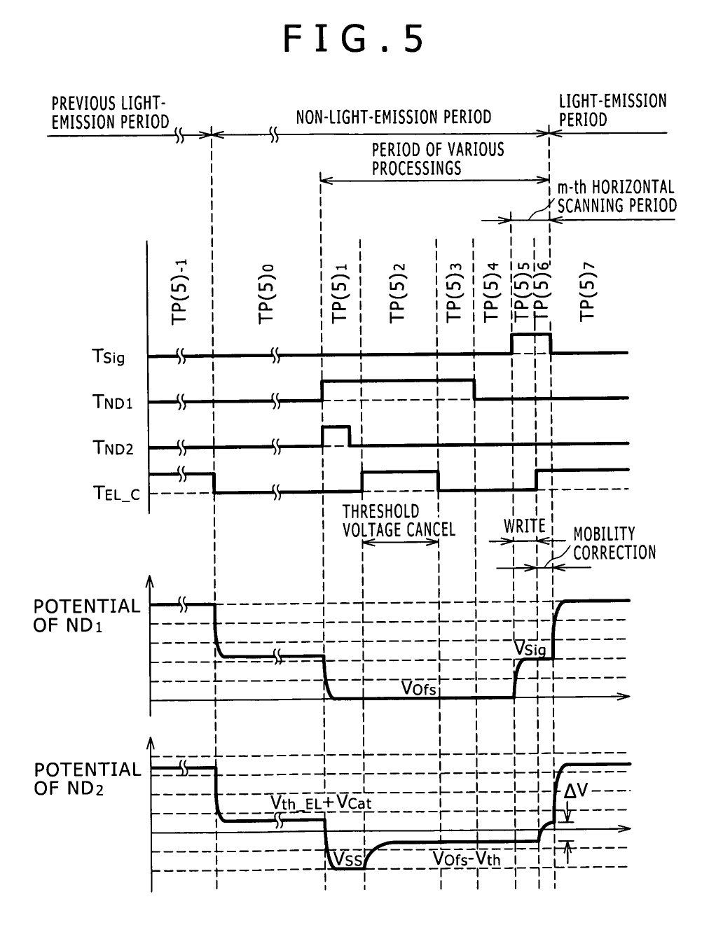

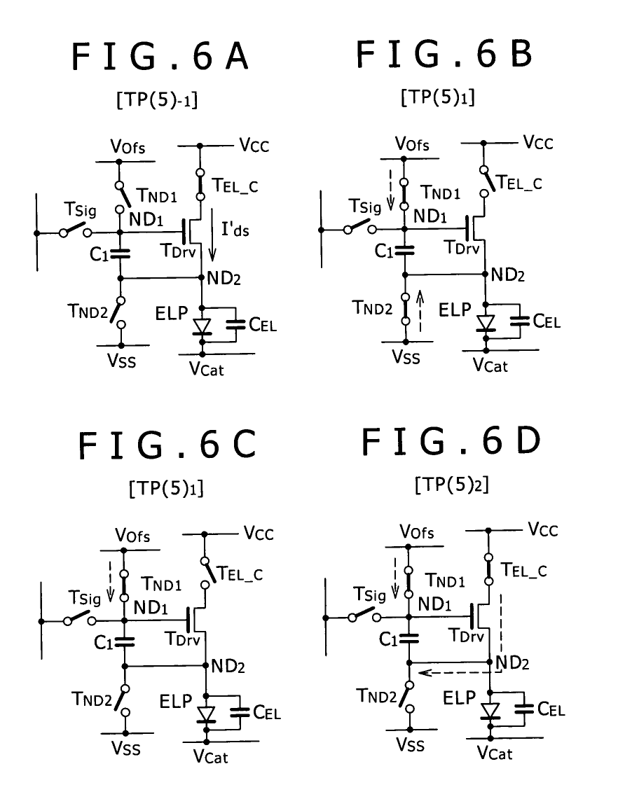

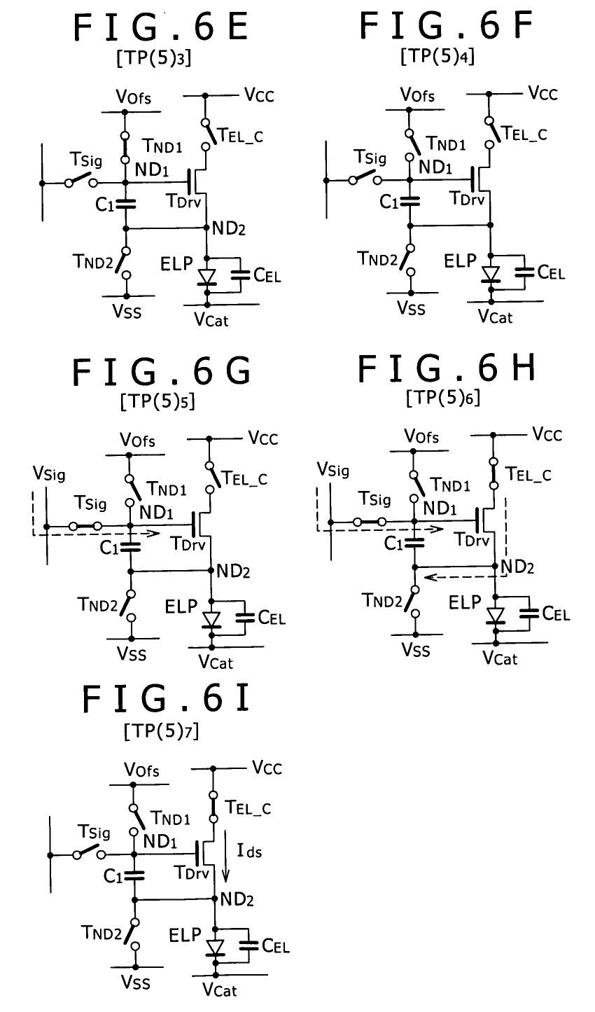

FIGS. 2 and 3 are equivalent circuit diagrams of the 5Tr/1C drive circuit. FIG. 4 is a conceptual diagram of a display including the 5Tr/1C drive circuits. FIG. 5 is a schematic timing chart showing the driving of the 5Tr/1C drive circuit. FIGS. 6A to 6I schematically show the on/off-states of the respective transistors and so on. In FIGS. 6, 11, 16, and 21, which schematically show the driving states, illustration of the auxiliary capacitor C_{Sub} is omitted.

This 5Tr/1C drive circuit includes five transistors of the video signal write transistor T_{Sig}, the drive transistor T_{Drv}, a light-emission control transistor T_{EL}_{_{—}}_{C}, a first-node initialization transistor T_{ND1}, and a second-node initialization transistor T_{ND2}. Furthermore, this circuit includes one capacitor C₁.

### [Light-Emission Control Transistor T_{EL}_{_{—}}_{C}]

One source/drain region of the light-emission control transistor T_{EL}_{_{—}}_{C} is connected to the current supply unit 100 (voltage V_{CC}). The other source/drain region of the light-emission control transistor T_{EL}_{_{—}}_{C} is connected to one source/drain region of the drive transistor T_{Drv}. The on/off operation of the light-emission control transistor T_{EL}_{_{—}}_{C} is controlled by a light-emission control transistor control line CL_{EL}_{_{—}}_{C} connected to the gate electrode of the light-emission control transistor T_{EL}_{_{—}}_{C}. The current supply unit 100 is provided to supply a current to the light-emitting part ELP of the organic EL element 10 to thereby control the light emission of the light-emitting part ELP. The light-emission control transistor control line CL_{EL}_{_{—}}_{C} is connected to a light-emission control transistor control circuit 103.

### [Drive Transistor T_{Drv}]

One source/drain region of the drive transistor T_{Drv} is connected to the other source/drain region of the light-emission control transistor T_{EL}_{_{—}}_{C}, as described above. That is, one source/drain region of the drive transistor T_{Drv} is connected to the current supply unit 100 via the light-emission control transistor T_{EL}_{_{—}}_{C}. On the other hand, the other source/drain region of the drive transistor T_{Drv} is connected to:

(1) the anode electrode of the light-emitting part ELP,
(2) the other source/drain region of the second-node initialization transistor T_{ND2}, and
(3) one electrode of the capacitor C₁,

and is equivalent to the second node ND₂. In addition, the gate electrode of the drive transistor T_{Drv} is connected to:

(1) the other source/drain region of the video signal write transistor T_{Sig},
(2) the other source/drain region of the first-node initialization transistor T_{ND1}, and
(3) the other electrode of the capacitor C₁, and is equivalent to the first node ND₁.

In the light-emission state of the organic EL element 10, the drive transistor T_{Drv} is so driven that a drain current I_{ds} flows through the drive transistor T_{Drv} in accordance with Equation (1) shown below. In the light-emission state of the organic EL element 10, one source/drain region of the drive transistor T_{Drv} serves as the drain region, and the other source/drain region thereof serves as the source region. For convenience of explanation, in the following description, one source/drain region of the drive transistor T_{Drv} will be often referred to simply as the drain region, and the other source/drain region thereof will be often referred to simply as the source region. The meanings of the respective symbols for Equation (1) are as follows.

μ: effective mobility
L: channel length
W: channel width
V_{gs}: potential difference between the gate electrode and the source region
Vₜₕ: threshold voltage
Cₒₓ: (the relative dielectric constant of the gate insulating layer)×(permittivity in vacuum)/(the thickness of the gate insulating layer)

k≡(½)·(W/L)·Cₒₓ

I_{ds}=k·μ·(V_{gs}−Vₜₕ)² (1)

Due to the flowing of this drain current I_{ds} through the light-emitting part ELP of the organic EL element 10, the light-emitting part ELP of the organic EL element 10 emits light. Moreover, depending on the magnitude of the drain current I_{ds}, the light-emission state (luminance) of the light-emitting part ELP of the organic EL element 10 is controlled.

### [Video Signal Write Transistor T_{Sig}]

The other source/drain region of the video signal write transistor T_{Sig} is connected to the gate electrode of the drive transistor T_{Drv}, as described above. One source/drain region of the video signal write transistor T_{Sig} is connected to the data line DTL. A drive signal (luminance signal) V_{Sig} for controlling the luminance of the light-emitting part ELP is supplied from the video signal output circuit 102 via the data line DTL to one source/drain region. Various kinds of signals and voltages other than V_{Sig} (signal for precharge driving, various reference voltages, etc.) may be supplied to one source/drain region via the data line DTL. The on/off operation of the video signal write transistor T_{Sig} is controlled by the scan line SCL connected to the gate electrode of the video signal write transistor T_{Sig}.

[First-Node Initialization Transistor T_{ND1}]

The other source/drain region of the first-node initialization transistor T_{ND1} is connected to the gate electrode of the drive transistor T_{Drv}, as described above. To one source/drain region of the first-node initialization transistor T_{ND1}, a voltage V_{Ofs} for initializing the potential of the first node ND₁ (i.e., the potential of the gate electrode of the drive transistor T_{Drv}) is supplied. The on/off operation of the first-node initialization transistor T_{ND1} is controlled by a first-node initialization transistor control line AZ_{ND1} connected to the gate electrode of the first-node initialization transistor T_{ND1}. The first-node initialization transistor control line AZ_{ND1} is connected to a first-node initialization transistor control circuit 104.

### [Second-Node Initialization Transistor T_{ND2}]

The other source/drain region of the second-node initialization transistor T_{ND2} is connected to the source region of the drive transistor T_{Drv}, as described above. To one source/drain region of the second-node initialization transistor T_{ND2}, a voltage V_{SS} for initializing the potential of the second node ND₂ (i.e., the potential of the source region of the drive transistor T_{Drv}) is supplied. The on/off operation of the second-node initialization transistor T_{ND2} is controlled by a second-node initialization transistor control line AZ_{ND2} connected to the gate electrode of the second-node initialization transistor T_{ND2}. The second-node initialization transistor control line AZ_{ND2} is connected to a second-node initialization transistor control circuit 105.

### [Light-Emitting Part ELP]

The anode electrode of the light-emitting part ELP is connected to the source region of the drive transistor T_{Drv}, as described above. To the cathode electrode of the light-emitting part ELP, a voltage V_{Cat} is applied. The parasitic capacitor of the light-emitting part ELP is represented by symbol C_{EL}. Furthermore, the threshold voltage necessary for the light emission of the light-emitting part ELP is represented as V_{th-EL}. That is, the light-emitting part ELP emits light when a voltage equal to or higher than V_{th-EL} is applied between the anode electrode and cathode electrode of the light-emitting part ELP.

For the following description, the values of the voltages and potentials are defined as follows. However, these values are merely examples for the description and the voltages and potentials are not limited to these values.

V_{Sig}: drive signal (luminance signal) for controlling the luminance of the light-emitting part ELP
0 volt to 10 volts
   V_{CC}: voltage of the current supply unit for controlling the light emission of the light-emitting part ELP
20 volts
   V_{Ofs}: voltage for initializing the potential of the gate electrode of the drive transistor T_{Drv} (the potential of the first node ND₁)
0 volt
   V_{SS}: voltage for initializing the potential of the source region of the drive transistor T_{Drv} (the potential of the second node ND₂)
−10 volts
   Vₜₕ: threshold voltage of the drive transistor T_{Drv}
3 volts
   V_{Cat}: voltage applied to the cathode electrode of the light-emitting part ELP
0 volt
   V_{th-EL}: threshold voltage of the light-emitting part ELP
3 volts

The operation of the 5Tr/1C drive circuit will be described below. The description is based on the assumption that the light-emission state starts immediately after the completion of all of various kinds of processing (threshold voltage cancel processing, write processing, and mobility correction processing), as described above. However, the operation is not limited thereto. This applies also to the explanation of the 4Tr/1C drive circuit, the 3Tr/1C drive circuit, and the 2Tr/1C drive circuit to be described later.

### [Period-TP(5)₋₁] (See FIG. 6A)

[period-TP(5)₋₁] corresponds to the operation in the previous display frame, for example. In this period, the (n, m)-th organic EL element 10 is in the light-emission state after the previous completion of various kinds of processing. Specifically, a drain current I′_{ds} based on Equation (5) to be described later flows through the light-emitting part ELP in the organic EL element 10 of the (n, m)-th sub-pixel, and the luminance of the organic EL element 10 of the (n, m)-th sub-pixel depends on this drain current I′_{ds}. The video signal write transistor T_{Sig}, the first-node initialization transistor T_{ND1}, and the second-node initialization transistor T_{ND2} are in the off-state. The light-emission control transistor T_{EL}_{_{—}}_{C} and the drive transistor T_{Drv} are in the on-state. The light-emission state of the (n, m)-th organic EL element 10 is continued until the timing immediately before the start of the horizontal scanning period of the organic EL elements 10 arranged on the (m+m′)-th row.

The period from [period-TP(5)₀] to [period-TP(5)₄] shown in FIG. 5 is the operation period from the end of the light-emission state after the previous completion of various kinds of processing to the timing immediately before the start of the next write processing. Specifically, this period from [period-TP(5)₀] to [period-TP(5)₄] is e.g. the period with a certain time length from the start of the (m+m′)-th horizontal scanning period in the previous display frame to the end of the (m−1)-th horizontal scanning period in the current display frame. It is also possible to employ a configuration in which the period from [period-TP(5)₁] to [period-TP(5)₄] is included in the m-th horizontal scanning period in the current display frame.

In this period from [period-TP(5)₀] to [period-TP(5)₄], the (n, m)-th organic EL element 10 is in the non-light-emission state. Specifically, the organic EL element 10 does not emit light because the light-emission control transistor T_{EL}_{_{—}}_{C} is in the off-state in the period from [period-TP(5)₀] to [period-TP(5)₁] and the period from [period-TP(5)₃] to [period-TP(5)₄]. In [period-TP(5)₂], the light-emission control transistor T_{EL}_{_{—}}_{C} is in the on-state. However, the threshold voltage cancel processing to be described later is executed in this period. Therefore, the organic EL element 10 does not emit light on condition that Inequality (2) to be described later is satisfied. This feature will be described in detail later in the explanation of the threshold voltage cancel processing.

The respective periods of [period-TP(5)₀] to [period-TP(5)₄] will be described below. The start timing of [period-TP(5)₁] and the lengths of the respective periods of [period-TP(5)₁] to [period-TP(5)₄] are properly defined depending on the design of the organic EL display.

### [Period-TP(5)₀]

In [period-TP(5)₀], the (n, m)-th organic EL element 10 is in the non-light-emission state, as described above. The video signal write transistor T_{Sig}, the first-node initialization transistor T_{ND1}, and the second-node initialization transistor T_{ND2} are in the off-state. At the timing of the transition from [period-TP(5)₋₁] to [period-TP(5)₀], the light-emission control transistor T_{EL}_{_{—}}_{C} is turned to the off-state. Thus, the potential of the second node ND₂ (the source region of the drive transistor T_{Drv} and the anode electrode of the light-emitting part ELP) decreases to (V_{th-EL}+V_{Cat}), so that the light-emitting part ELP enters the non-light-emission state. Furthermore, the potential of the first node ND₁′ (the gate electrode of the drive transistor T_{Drv}) in the floating state also decreases in such a manner as to follow the potential decrease of the second node ND₂.

### [Period-TP(5)₁] (See FIGS. 6B and 6C)

In [period-TP(5)₁], preprocessing for execution of the threshold voltage cancel processing, to be described later, is executed. Specifically, at the start of [period-TP(5)₁], the first-node initialization transistor T_{ND1} and the second-node initialization transistor T_{ND2} are turned to the on-state by switching the first-node initialization transistor control line AZ_{ND1} and the second-node initialization transistor control line AZ_{ND2} to the high level based on the operation of the first-node initialization transistor control circuit 104 and the second-node initialization transistor control circuit 105. As a result, the potential of the first node ND₁ becomes V_{Ofs} (e.g. 0 volt), and the potential of the second node ND₂ becomes V_{SS} (e.g. −10 volts). Before the end of [period-TP(5)₁], the second-node initialization transistor T_{ND2} is turned to the off-state by switching the second-node initialization transistor control line AZ_{ND2} to the low level based on the operation of the second-node initialization transistor control circuit 105. The first-node initialization transistor T_{ND1} and the second-node initialization transistor T_{ND2} may be simultaneously turned to the on-state. Alternatively, one of these transistors may be turned to the on-state previous to the other transistor.

Due to the above-described processing, the potential difference between the gate electrode and source region of the drive transistor T_{Drv} becomes equal to or larger than Vₜₕ, so that the drive transistor T_{Drv} enters the on-state.

### [Period-TP(5)₂] (See FIG. 6D)

Subsequently, the threshold voltage cancel processing is executed. Specifically, with the first-node initialization transistor T_{ND1} kept at the on-state, the light-emission control transistor T_{EL}_{_{—}}_{C} is turned to the on-state by switching the light-emission control transistor control line CL_{EL}_{_{—}}_{C} to the high level based on the operation of the light-emission control transistor control circuit 103. As a result, the potential of the second node ND₂ in the floating state rises up whereas the potential of the first node ND₁ does not change (but is kept at V_{Ofs}=0 volts), so that the potential difference between the first node ND₁ and the second node ND₂ approaches the threshold voltage Vₜₕ of the drive transistor T_{Drv}. When the potential difference between the gate electrode and source region of the drive transistor T_{Drv} has reached Vₜₕ, the drive transistor T_{Drv} is turned to the off-state. Specifically, the potential of the second node ND₂ in the floating state approaches (V_{Ofs}−Vₜₕ=−3 volts>V_{SS}), and eventually becomes (V_{Ofs}−Vₜₕ). At this time, the light-emitting part ELP does not emit light as long as Inequality (2) shown below is assured, in other words, as long as the potentials are so selected and determined as to satisfy Inequality (2). In a qualitative sense, the time of the threshold voltage cancel processing affects the degree of the approaching of the potential difference between the first node ND₁ and the second node ND₂ (i.e., the potential difference between the gate electrode and source region of the drive transistor T_{Drv}) to the threshold voltage Vₜₕ of the drive transistor T_{Drv} in the threshold voltage cancel processing. Therefore, if a sufficiently long time is ensured as the time of the threshold voltage cancel processing, the potential difference between the first node ND₁ and the second node ND₂ will reach the threshold voltage Vₜₕ of the drive transistor T_{Drv}, so that the drive transistor T_{Drv} will enter the off-state. In contrast, if the time of the threshold voltage cancel processing is set short, the eventual potential difference between the first node ND₁ and the second node ND₂ will be larger than the threshold voltage Vₜₕ of the drive transistor T_{Drv} and thus the drive transistor T_{Drv} will not enter the off-state in some cases. That is, the drive transistor T_{Drv} does not necessarily need to enter the off-state as a result of the threshold voltage cancel processing.

(V_{Ofs}−Vₜₕ)<(V_{th-EL}+V_{Cat}) (2)

In [period-TP(5)₂], the potential of the second node ND₂ eventually becomes (V_{Ofs}−Vₜₕ), for example. Specifically, the potential of the second node ND₂ is determined depending only on the threshold voltage Vₜₕ of the drive transistor T_{Drv} and the voltage V_{Ofs} for initializing the gate electrode of the drive transistor T_{Drv}. In other words, the potential does not depend on the threshold voltage V_{th-EL} of the light-emitting part ELP.

### [Period-TP(5)₃] (See FIG. 6E)

With the first-node initialization transistor T_{ND1} kept at the on-state, the light-emission control transistor T_{EL}_{_{—}}_{C} is turned to the off-state by switching the light-emission control transistor control line CL_{EL}_{_{—}}_{C} to the low level based on the operation of the light-emission control transistor control circuit 103. As a result, the potential of the first node ND₁ is not changed (but kept at V_{Ofs}=0 volt), and the potential of the second node ND₂ in the floating state is also not changed but kept at (V_{Ofs}−Vₜₕ=−3 volts).

### [Period-TP(5)₄] (See FIG. 6F)

Subsequently, the first-node initialization transistor T_{ND1} is turned to the off-state by switching the first-node initialization transistor control line AZ_{ND1} to the low level based on the operation of the first-node initialization transistor control circuit 104. The potentials of the first node ND₁ and the second node ND₂ do not change substantially. (Actually, potential changes will possibly occur due to electrostatic coupling of parasitic capacitors and so on, but these changes can generally be ignored).

The respective periods of [period-TP(5)₅] to [period-TP(5)₇] will be described below. As described later, write processing is executed in [period-TP(5)₅], and mobility correction processing is executed in [period-TP(5)₆]. As described above, these processings should be executed within the m-th horizontal scanning period. For convenience of explanation, the following description is based on the assumption that the start timing of [period-TP(5)₅] and the end timing of [period-TP(5)₆] correspond with the start timing and end timing of the m-th horizontal scanning period, respectively.

### [Period-TP(5)₅] (See FIG. 6G)

The write processing for the drive transistor T_{Drv} is executed. Specifically, in the state in which the first-node initialization transistor T_{ND1}, the second-node initialization transistor T_{ND2}, and the light-emission control transistor T_{EL}_{_{—}}_{C} are kept at the off-state, the potential of the data line DTL is set to the drive signal (luminance signal) V_{Sig} for controlling the luminance of the light-emitting part ELP based on the operation of the video signal output circuit 102, and then the video signal write transistor T_{Sig} is turned to the on-state by switching the scan line SCL to the high level based on the operation of the scan line 101. As a result, the potential of the first node ND₁ rises up to V_{Sig}.

The capacitance of the capacitor C₁ is c₁, and the capacitance of the parasitic capacitor C_{EL} of the light-emitting part ELP is c_{EL}. Furthermore, the capacitance of the parasitic capacitor between the gate electrode and source region of the drive transistor T_{Drv} is defined as c_{gs}. In response to the change of the potential of the gate electrode of the drive transistor T_{Drv} from V_{Ofs} to V_{Sig} (>V_{Ofs}), the potentials of both ends of the capacitor C₁ (the potentials of the first node ND₁ and the second node ND₂) change in principle. Specifically, charges based on the change (V_{Sig}−V_{Ofs}) of the potential of the gate electrode of the drive transistor T_{Drv} (=the potential of the first node ND₁) are distributed into the capacitor C₁, the parasitic capacitor C_{EL} of the light-emitting part ELP, the auxiliary capacitor C_{Sub} (in the case of a drive circuit connected to the auxiliary capacitor C_{Sub}), and the parasitic capacitor between the gate electrode and source region of the drive transistor T_{Drv}. If the capacitances c_{EL} and c_{Sub} are sufficiently higher than the capacitances c₁ and c_{gs}, the change of the potential of the source region of the drive transistor T_{Drv} (second node ND₂), based on the change (V_{Sig}−V_{Ofs}) of the potential of the gate electrode of the drive transistor T_{Drv}, is small. In general, the capacitance C_{EL} of the parasitic capacitor C_{EL} of the light-emitting part ELP is higher than the capacitance c₁ of the capacitor C₁ and the capacitance c_{gs} of the parasitic capacitor of the drive transistor T_{Drv}. Therefore, for convenience of explanation, the following description will be made without taking into consideration the potential change of the second node ND₂ arising due to the potential change of the first node ND₁, unless there is a particular need to take into consideration the potential change. This applies also to the other drive circuits. The driving timing chart of FIG. 5 is also shown without taking into consideration the potential change of the second node ND₂ arising due to the potential change of the first node ND₁. When the potential of the gate electrode of the drive transistor T_{Drv} (first node ND₁) is defined as V_{g} and the potential of the source region of the drive transistor T_{Drv} (second node ND₂) is defined as Vₛ, the values of V_{g} and Vₛ are represented below. Therefore, the potential difference between the first node ND₁ and the second node ND₂, i.e., the potential difference V_{gs} between the gate electrode and source region of the drive transistor T_{Drv}, can be represented by Equation (3).

V_{g}=V_{Sig}

Vₛ≈V_{Ofs}−Vₜₕ

V_{gs}≈V_{Sig}−(V_{Ofs}−Vₜₕ) (3)

Specifically, the potential difference V_{gs} resulting from the write processing for the drive transistor T_{Drv} depends only on the drive signal (luminance signal) V_{Sig} for controlling the luminance of the light-emitting part ELP, the threshold voltage Vₜₕ of the drive transistor T_{Drv}, and the voltage V_{Ofs} for initializing the gate electrode of the drive transistor T_{Drv}. Furthermore, the potential difference V_{gs} is irrespective of the threshold voltage V_{th-EL} of the light-emitting part ELP.

### [Period-TP(5)₆] (See FIG. 6H)

Correction of the potential of the source region of the drive transistor T_{Drv} (second node ND₂), based on the magnitude of the mobility μ of the drive transistor T_{Drv} (mobility correction processing), is carried out.

In general, when the drive transistor T_{Drv} is fabricated by a poly-silicon thin film transistor or the like, it is difficult to avoid the occurrence of variation in the mobility μ among the transistors. Therefore, when the drive signal V_{Sig} of the same value is applied to the gate electrodes of the plural drive transistors T_{Drv} involving a difference in the mobility μ, a difference will arise between the drain current I_{ds} that flows through the drive transistor T_{Drv} having high mobility μ and the drain current I_{ds} that flows through the drive transistor T_{Drv} having low mobility μ. The occurrence of such difference will deteriorate the uniformity of the screen of the organic EL display.

To address this problem, specifically, with the drive transistor T_{Drv} kept at the on-state, the light-emission control transistor T_{EL}_{_{—}}_{C} is turned to the on-state by switching the light-emission control transistor control line CL_{EL}_{_{—}}_{C} to the high level based on the operation of the light-emission control transistor control circuit 103. Subsequently, after the elapse of a predetermined time (t₀), the video signal write transistor T_{Sig} is turned to the off-state by switching the scan line SCL to the low level based on the operation of the scan circuit 101, to thereby turn the first node ND₁ (the gate electrode of the drive transistor T_{Drv}) to the floating state. As a result of this operation, when the mobility μ of the drive transistor T_{Drv} is high, the rise amount ΔV of the potential (potential correction value) of the source region of the drive transistor T_{Drv} is large. In contrast, when the mobility μ of the drive transistor T_{Drv} is low, the rise amount ΔV of the potential (potential correction value) of the source region of the drive transistor T_{Drv} is small. The potential difference V_{gs} between the gate electrode and source region of the drive transistor T_{Drv}, originally represented by Equation (3), is modified to the potential difference V_{gs} represented by Equation (4).

V_{gs}≈V_{Sig}−(V_{Ofs}−Vₜₕ)−ΔV (4)

The predetermined time (the total time to of [period-TP(5)₆]) for executing the mobility correction processing is determined as a design value in advance at the time of the designing of the organic EL display. Furthermore, the total time to of [period-TP(5)₆] is so determined that the potential (V_{Ofs}−Vₜₕ+ΔV) of the source region of the drive transistor T_{Drv}, resulting from the mobility correction processing, satisfies Inequality (2′). Due to this feature, the light-emitting part ELP does not emit light in [period-TP(5)₆]. Moreover, in this mobility correction processing, correction of variation in the coefficient k(≡(½)·(W/L)Cₒₓ) is simultaneously carried out.

(V_{Ofs}−Vₜₕ+ΔV)<(V_{th-EL}+V_{Cat}) (2′)

### [Period-TP(5)₇] (See FIG. 6I)

Through the above-described operation, the threshold voltage cancel processing, the write processing, and the mobility correction processing are completed. As a result of the switching of the scan line SCL to the low level based on the operation of the scan circuit 101, the video signal write transistor T_{Sig} is turned to the off-state, so that the first node ND₁, i.e., the gate electrode of the drive transistor T_{Drv}, enters the floating state. On the other hand, the light-emission control transistor T_{EL}_{_{—}}_{C} is kept at the on-state, and the drain region thereof is in the state of being connected to the current supply unit 100 (voltage V_{CC}, e.g. 20 volts) for controlling the light emission of the light-emitting part ELP. Consequently, as a result of the above-described operation, the potential of the second node ND₂ rises.

As described above, the gate electrode of the drive transistor T_{Drv} is in the floating state, and the capacitor C₁ exists. Therefore, the same phenomenon as that in a so-called bootstrap circuit occurs at the gate electrode of the drive transistor T_{Drv}, so that the potential of the first node ND₁ also rises. As a result, the value of Equation (4) is kept as the potential difference V_{gs} between the gate electrode and source region of the drive transistor T_{Drv}.

Furthermore, the potential of the second node ND₂ rises and surpasses (V_{th-EL}+V_{Cat}), and thus the light-emitting part ELP starts light emission. At this time, the current that flows through the light-emitting part ELP is the drain current I_{ds} that flows from the drain region of the drive transistor T_{Drv} to the source region thereof. Therefore, the current can be represented by Equation (1). From Equations (1) and (4), Equation (1) can be modified to Equation (5).

I_{ds}=k·μ·(V_{Sig}−V_{Ofs}−ΔV)² (5)

Therefore, when V_{Ofs} is set to 0 volt, for example, the current I_{ds} flowing through the light-emitting part ELP is in proportion to the square of the value obtained by subtracting the potential correction value ΔV for the second node ND₂ (the source region of the drive transistor T_{Drv}), dependent upon the mobility μ of the drive transistor T_{Drv} from the value of the drive signal (luminance signal) V_{Sig} for controlling the luminance of the light-emitting part ELP. In other words, the current I_{ds} that flows through the light-emitting part ELP does not depend on the threshold voltage V_{th-EL} of the light-emitting part ELP and the threshold voltage Vₜₕ of the drive transistor T_{Drv}. That is, the light-emission amount (luminance) of the light-emitting part ELP is not affected by the threshold voltage V_{th-EL} of the light-emitting part ELP and the threshold voltage Vₜₕ of the drive transistor T_{Drv}. In addition, the luminance of the (n, m)-th organic EL element 10 depends on this current I_{ds}.

Moreover, for the drive transistor T_{Drv} having higher mobility μ, the potential correction value ΔV becomes larger, and hence the value of V_{gs} on the left side of Equation (4) becomes smaller. Consequently, in Equation (5), the value of (V_{Sig}−V_{Ofs}−ΔV)² becomes small although the value of the mobility μ is large. As a result, the drain current I_{ds} can be corrected. Specifically, even for the drive transistors T_{Drv} involving difference in the mobility μ, substantially the same drain current I_{ds} is obtained with respect to the drive signal (luminance signal) V_{Sig} of the same value. As a result, the current I_{ds} that flows through the light-emitting part ELP and controls the luminance of the light-emitting part ELP is uniformed. That is, variation in the luminance of the light-emitting part attributed to variation in the mobility μ (and variation in k) can be corrected.

The light-emission state of the light-emitting part ELP is continued until the end of the (m+m′−1)-th horizontal scanning period. This timing is equivalent to the end of [period-TP(5)₋₁].

Through the above-described steps, the light-emission operation of the organic EL element 10 (the (n, m)-th sub-pixel (organic EL element 10)) is completed.

As described above, the predetermined time (the total time t₀ of [period-TP(5)₆]) for executing the mobility correction processing is determined as a design value in advance at the time of the designing of the organic EL display. However, lower capacitance c_{EL} of the parasitic capacitor C_{EL} of the light-emitting part ELP leads to higher speed of the rise amount ΔV of the potential (potential correction value) of the source region of the drive transistor T_{Drv}. As a result, as described above for the embodiments, the time t of actual [period-TP(5)₆] needs to be shortened. Therefore, it is very difficult to control the execution time of the mobility correction processing. Furthermore, when there is large relative variation in the capacitance c_{EL} of the parasitic capacitor C_{EL} of the light-emitting part ELP, a large variation will arise in the rise amount ΔV of the potential (potential correction value) of the source region of the drive transistor T_{Drv}. However, in the organic EL display of the embodiments, the auxiliary capacitor C_{Sub} is connected to the source region of the drive transistor T_{Drv} (second node ND₂). This can decrease the rising speed of the potential of the source region of the drive transistor T_{Drv} (second node ND₂) in the mobility correction processing, and thus can extend the execution time of the mobility correction processing. This results in facilitation of control of the time of the mobility correction processing. Furthermore, variation in the capacitance c_{EL} of the parasitic capacitor C_{EL} of the light-emitting part ELP can be reduced relatively, which can prevent the occurrence of a large variation in the rise amount ΔV of the potential (potential correction value) of the source region of the drive transistor T_{Drv} (second node ND₂). Moreover, the size of the light-emitting part ELP does not need to be changed depending on the kind of sub-pixel. This allows reduction in the current density of the current that flows through the light-emitting part ELP, and thus can realize the extension of the lifetime of the organic EL element. These features apply also to the 4Tr/1C drive circuit, the 3Tr/1C drive circuit, and the 2Tr/1C drive circuit to be described later.

The 4Tr/1C drive circuit will be described below.

### [4Tr/1C Drive Circuit]

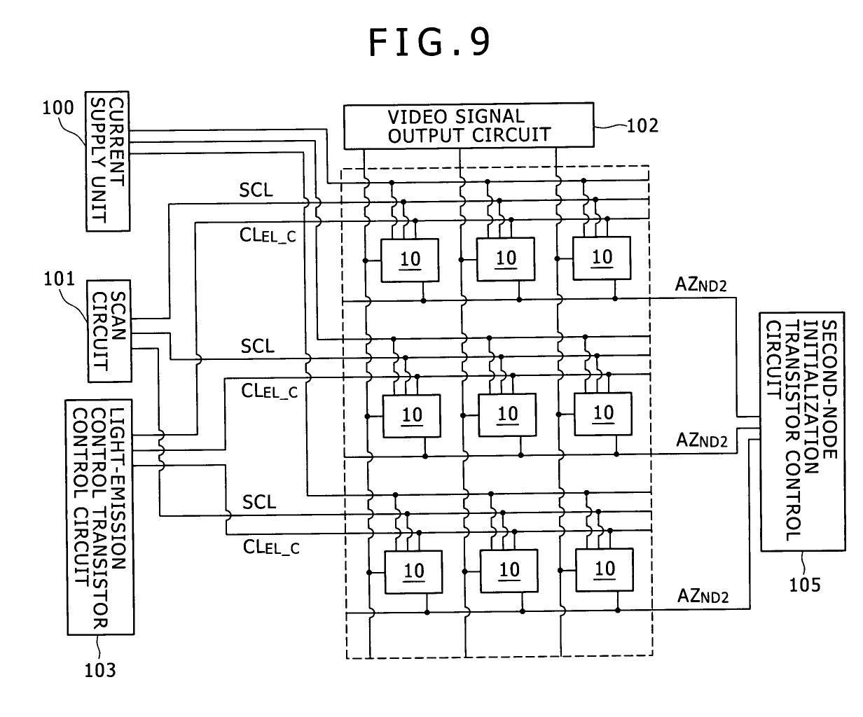

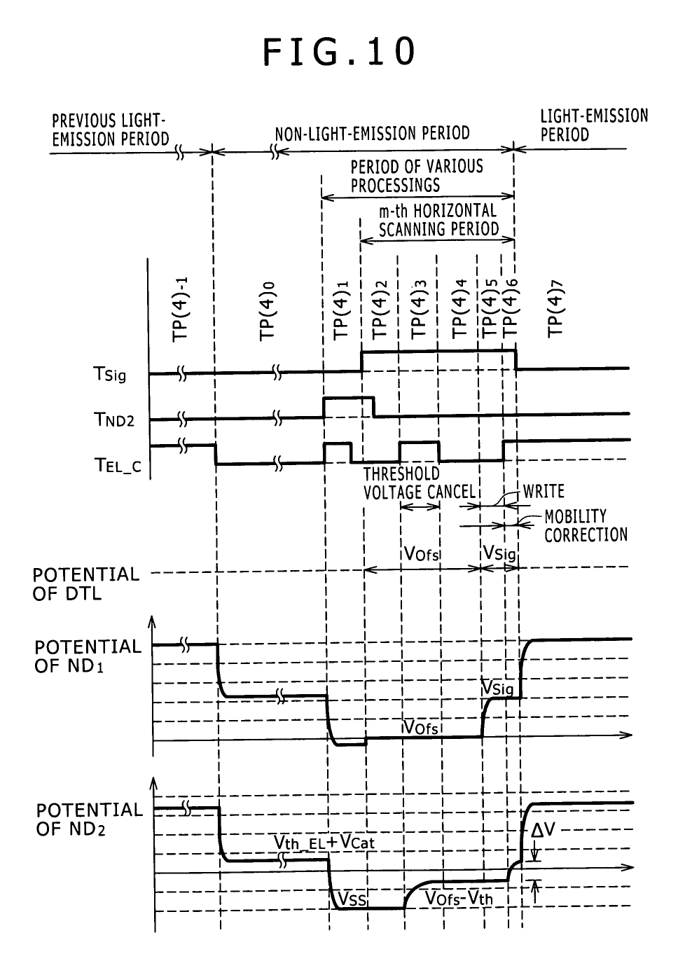

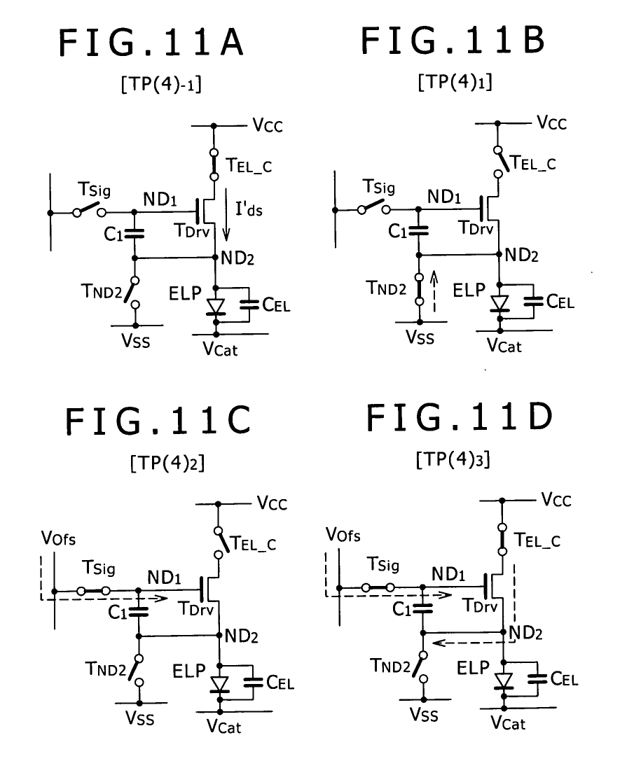

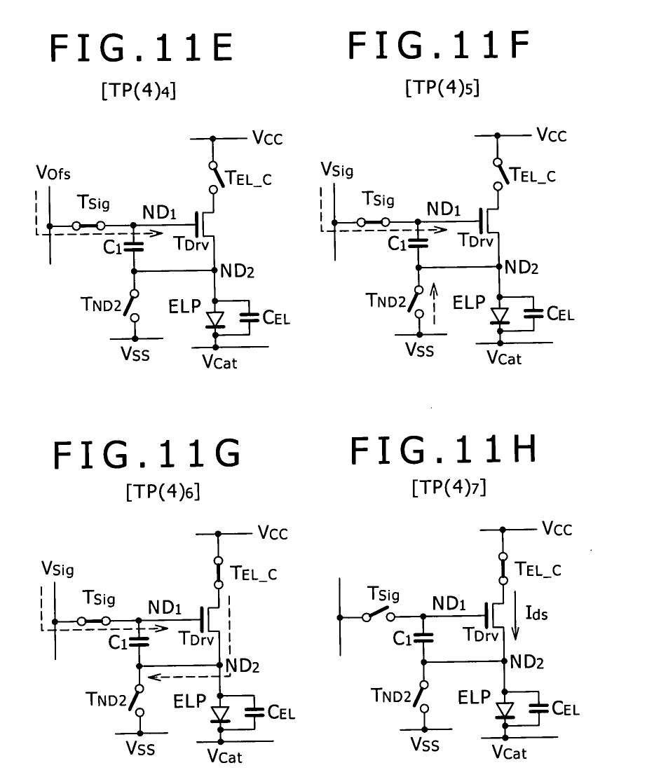

FIGS. 7 and 8 are equivalent circuit diagrams of the 4Tr/1C drive circuit. FIG. 9 is a conceptual diagram of a display including the 4Tr/1C drive circuits. FIG. 10 is a schematic timing chart showing the driving of the 4Tr/1C drive circuit. FIGS. 11A to 11H schematically show the on/off-states of the respective transistors and so on.

This 4Tr/1C drive circuit is obtained by omitting the first-node initialization transistor T_{ND1} from the above-described 5Tr/1C drive circuit. Specifically, this 4Tr/1C drive circuit includes four transistors of the video signal write transistor T_{Sig}, the drive transistor T_{Drv}, the light-emission control transistor T_{EL}_{_{—}}_{C}, and the second-node initialization transistor T_{ND2}. Furthermore, this circuit includes one capacitor C₁.

### [Light-Emission Control Transistor T_{EL}_{_{—}}_{C}]

The configuration of the light-emission control transistor T_{EL}_{_{—}}_{C} is the same as that of the light-emission control transistor T_{EL}_{_{—}}_{C} described for the 5Tr/1C drive circuit, and therefore, the detailed description thereof is omitted.

### [Drive Transistor T_{Drv}]

The configuration of the drive transistor T_{Drv} is the same as that of the drive transistor T_{Drv} described for the 5Tr/1C drive circuit, and therefore, the detailed description thereof is omitted.

### [Second-Node Initialization Transistor T_{ND2}]

The configuration of the second-node initialization transistor T_{ND2} is the same as that of the second-node initialization transistor T_{ND2} described for the 5Tr/1C drive circuit, and therefore, the detailed description thereof is omitted.

### [Video Signal Write Transistor T_{Sig}]

The configuration of the video signal write transistor T_{Sig} is the same as that of the video signal write transistor T_{Sig} described for the 5Tr/1C drive circuit, and therefore, the detailed description thereof is omitted. However, to one source/drain region of the video signal write transistor T_{Sig}, which is connected to the data line DTL, not only the drive signal (luminance signal) V_{Sig} for controlling the luminance of the light-emitting part ELP but also the voltage V_{Ofs} for initializing the gate electrode of the drive transistor T_{Drv} is supplied from the video signal output circuit 102. This feature is different from the operation of the video signal write transistor T_{Sig} described for the 5Tr/1C drive circuit. Signals and voltages other than V_{Sig} and V_{Ofs} (e.g. a signal for precharge driving) may be supplied from the video signal output circuit 102 via the data line DTL to one source/drain region.

### [Light-Emitting Part ELP]

The configuration of the light-emitting part ELP is the same as that of the light-emitting part ELP described for the 5Tr/1C drive circuit, and therefore, the detailed description thereof is omitted.

The operation of the 4Tr/1C drive circuit will be described below.

### [Period-TP(4)₋₁] (See FIG. 11A)

[period-TP(4)₋₁] corresponds to the operation in the previous display frame, for example. In this period, the same operation as that in [period-TP(5)₋₁] described for the 5Tr/1C drive circuit is carried out.

The period from [period-TP(4)₀] to [period-TP(4)₄] shown in FIG. 10 is equivalent to the period from [period-TP(5)₀] to [period-TP(5)₄] shown in FIG. 5, and is the operation period until the timing immediately before the start of the next write processing. Furthermore, in this period from [period-TP(4)₀] to [period-TP(4)₄], the (n, m)-th organic EL element 10 is in the non-light-emission state, similar to the 5Tr/1C drive circuit. However, the operation of the 4Tr/1C drive circuit is different from the operation of the 5Tr/1C drive circuit, in that the period from [period-TP(4)₂] to [period-TP(4)₄] in addition to the period from [period-TP(4)₅] to [period-TP(4)₆] shown in FIG. 10 is included in the m-th horizontal scanning period. For convenience of explanation, the following description is based on the assumption that the start timing of [period-TP(4)₂] and the end timing of [period-TP(4)₆] correspond with the start timing and end timing of the m-th horizontal scanning period, respectively.

The respective periods of [period-TP(4)₀] to [period-TP(4)₄] will be described below. Similar to the 5Tr/1C drive circuit, the start timing of [period-TP(4)₁] and the lengths of the respective periods of [period-TP(4)₁] to [period-TP(4)₄] are properly defined depending on the design of the organic EL display.

### [Period-TP(4)₀]

[period-TP(4)₀] corresponds to the operation for the transition from the previous display frame to the current display frame, for example. In this period, substantially the same operation as that in [period-TP(5)₀] described for the 5Tr/1C drive circuit is carried out.

### [Period-TP(4)₁] (See FIG. 11B)

[period-TP(4)₁] is equivalent to [period-TP(5)₁] described for the 5Tr/1C drive circuit. In [period-TP(4)₁], preprocessing for execution of threshold voltage cancel processing to be described later is executed. At the start of [period-TP(4)₁], the second-node initialization transistor T_{ND2} is turned to the on-state by switching the second-node initialization transistor control line AZ_{ND2} to the high level based on the operation of the second-node initialization transistor control circuit 105. As a result, the potential of the second node ND₂ becomes V_{SS} (e.g. −10 volts). Furthermore, the potential of the first node ND₁ (the gate electrode of the drive transistor T_{Drv}) in the floating state also decreases in such a manner as to follow the potential decrease of the second node ND₂. The potential of the first node ND₁ in [period-TP(4)₁] depends on the potential of the first node ND₁ in [period-TP(4)₋₁] (defined depending on the value of V_{Sig} in the previous frame), and therefore, does not take a constant value.

### [Period-TP(4)₂] (See FIG. 11C)

The potential of the data line DTL is set to V_{Ofs} based on the operation of the video signal output circuit 102, and the video signal write transistor T_{Sig} is turned to the on-state by switching the scan line SCL to the high level based on the operation of the scan circuit 101. As a result, the potential of the first node ND₁ becomes V_{Ofs} (e.g. 0 volt). The potential of the second node ND₂ is kept at V_{SS} (e.g. −10 volts). Thereafter, the second-node initialization transistor T_{ND2} is turned to the off-state by switching the second-node initialization transistor control line AZ_{ND2} to the low level based on the operation of the second-node initialization transistor control circuit 105.

The video signal write transistor T_{Sig} may be turned to the on-state simultaneously with the start of [period-TP(4)₁] or in the middle of [period-TP(4)₁].

Due to the above-described processing, the potential difference between the gate electrode and source region of the drive transistor T_{Drv} becomes equal to or larger than Vₜₕ, so that the drive transistor T_{Drv} enters the on-state.

### [Period-TP(4)₃] (See FIG. 11D)

Subsequently, the threshold voltage cancel processing is executed. Specifically, with the video signal write transistor T_{Sig} kept at the on-state, the light-emission control transistor T_{EL}_{_{—}}_{C} is turned to the on-state by switching the light-emission control transistor control line CL_{EL}_{_{—}}_{C} to the high level based on the operation of the light-emission control transistor control circuit 103. As a result, the potential of the second node ND₂ in the floating state rises whereas the potential of the first node ND₁ does not change (but is kept at V_{Ofs}=0 volt) so that the potential difference between the first node ND₁ and the second node ND₂ approaches the threshold voltage Vₜₕ of the drive transistor T_{Drv}. When the potential difference between the gate electrode and source region of the drive transistor T_{Drv} has reached Vₜₕ, the drive transistor T_{Drv} is turned to the off-state. Specifically, the potential of the second node ND₂ in the floating state approaches (V_{Ofs}−Vₜₕ=−3 volts) and eventually becomes (V_{Ofs}−Vₜₕ). At this time, the light-emitting part ELP does not emit light as long as the above-described Inequality (2) is assured, in other words, as long as the potentials are so selected and determined as to satisfy Inequality (2).

In [period-TP(4)₃], the potential of the second node ND₂ eventually becomes (V_{Ofs}−Vₜₕ), for example. Specifically, the potential of the second node ND₂ is determined depending only on the threshold voltage Vₜₕ of the drive transistor T_{Drv} and the voltage V_{Ofs} for initializing the gate electrode of the drive transistor T_{Drv}. Furthermore, the potential is irrespective of the threshold voltage V_{th-EL} of the light-emitting part ELP.

### [Period-TP(4)₄] (See FIG. 11E)

With the video signal write transistor T_{Sig} kept at the on-state, the light-emission control transistor T_{EL}_{_{—}}_{C} is turned to the off-state by switching the light-emission control transistor control line CL_{EL}_{_{—}}_{C} to the low level based on the operation of the light-emission control transistor control circuit 103. As a result, the potential of the first node ND₁ is not changed (but kept at V_{Ofs}=0 volt), and the potential of the second node ND₂ in the floating state is also not substantially changed, but kept at (V_{Ofs}−Vₜₕ=−3 volts). (Actually, potential changes will possibly occur due to electrostatic coupling of parasitic capacitors and so on, but these changes can be ignored generally)

The respective periods of [period-TP(4)₅] to [period-TP(4)₇] will be described below. In these periods, substantially the same operations as those in the periods of [period-TP(5)₅] to [period-TP(5)₇], described for the 5Tr/1C drive circuit, are carried out.

### [Period-TP(4)₅] (See FIG. 11F)

The write processing for the drive transistor T_{Drv} is executed. Specifically, in the state in which the video signal write transistor T_{Sig} is kept at the on-state, whereas the second-node initialization transistor T_{ND2} and the light-emission control transistor T_{EL}_{_{—}}_{C} are kept at the off-state, the potential of the data line DTL is switched from V_{Ofs} to the drive signal (luminance signal) V_{Sig} for controlling the luminance of the light-emitting part ELP, based on the operation of the video signal output circuit 102. As a result, the potential of the first node ND₁ rises to V_{Sig}. The following procedure is also available for the write processing. Specifically, after the video signal write transistor T_{Sig} is temporarily turned to the off-state, in the state in which the video signal write transistor T_{Sig} the second-node initialization transistor T_{ND2}, and the light-emission control transistor T_{EL}_{_{—}}_{C} are kept at the off-state, and the potential of the data line DTL is changed to the drive signal (luminance signal) V_{Sig} for controlling the luminance of the light-emitting part ELP based on the operation of the video signal output circuit 102. Thereafter, with the second-node initialization transistor T_{ND2} and the light-emission control transistor T_{EL}_{_{—}}_{C} kept at the off-state, the video signal write transistor T_{Sig} is turned to the on-state by switching the scan line SCL to the high level.

Due to the write processing, similar to the 5Tr/1C drive circuit, the value described with Equation (3) can be obtained as the potential difference between the first node ND₁ and the second node ND₂, i.e., the potential difference V_{gs} between the gate electrode and source region of the drive transistor T_{Drv}.

Specifically, also in the 4Tr/1C drive circuit, the potential difference V_{gs} resulting from the write processing for the drive transistor T_{Drv} depends only on the drive signal (luminance signal) V_{Sig} for controlling the luminance of the light-emitting part ELP, the threshold voltage Vₜₕ of the drive transistor T_{Drv}, and the voltage V_{Ofs} for initializing the gate electrode of the drive transistor T_{Drv}. Furthermore, the potential difference V_{gs} is irrespective of the threshold voltage V_{th-EL} of the light-emitting part ELP.

### [Period-TP(4)₆] (See FIG. 11G)

Correction of the potential of the source region of the drive transistor T_{Drv} (second node ND₂) based on the magnitude of the mobility μ of the drive transistor T_{Drv} (mobility correction processing) is carried out. Specifically, the same operation as that in [period-TP(5)₆], described for the 5Tr/1C drive circuit, is carried out. The predetermined time (the total time to of [period-TP(4)₆]) for executing the mobility correction processing is determined as a design value in advance at the time of the designing of the organic EL display.

### [Period-TP(4)₇] (See FIG. 11H)

Through the above-described operation, the threshold voltage cancel processing, the write processing, and the mobility correction processing are completed. Subsequently, the same processing as that in [period-TP(5)₇], described for the 5Tr/1C drive circuit, is executed so that the potential of the second node ND₂ rises and surpasses (V_{th-EL}+V_{Cat}). Thus, the light-emitting part ELP starts light emission. The value of the current that flows through the light-emitting part ELP at this time can be obtained from the above-described Equation (5). Therefore, the current I_{ds} that flows through the light-emitting part ELP does not depend on the threshold voltage V_{th-EL} of the light-emitting part ELP and the threshold voltage Vₜₕ of the drive transistor T_{Drv}. That is, the light-emission amount (luminance) of the light-emitting part ELP is not affected by the threshold voltage V_{th-EL} of the light-emitting part ELP and the threshold voltage Vₜₕ of the drive transistor T_{Drv}. In addition, the occurrence of variation in the drain current I_{ds} attributed to variation in the mobility μ of the drive transistor T_{Drv} can be suppressed.

The light-emission state of the light-emitting part ELP is continued until the end of the (m+m′−1)-th horizontal scanning period. This timing is equivalent to the end of [period-TP(4)₋₁].

Through the above-described steps, the light-emission operation of the organic EL element 10 (the (n, m)-th sub-pixel (organic EL element 10)) is completed.

The 3Tr/1C drive circuit will be described below.

### [3Tr/1C Drive Circuit]

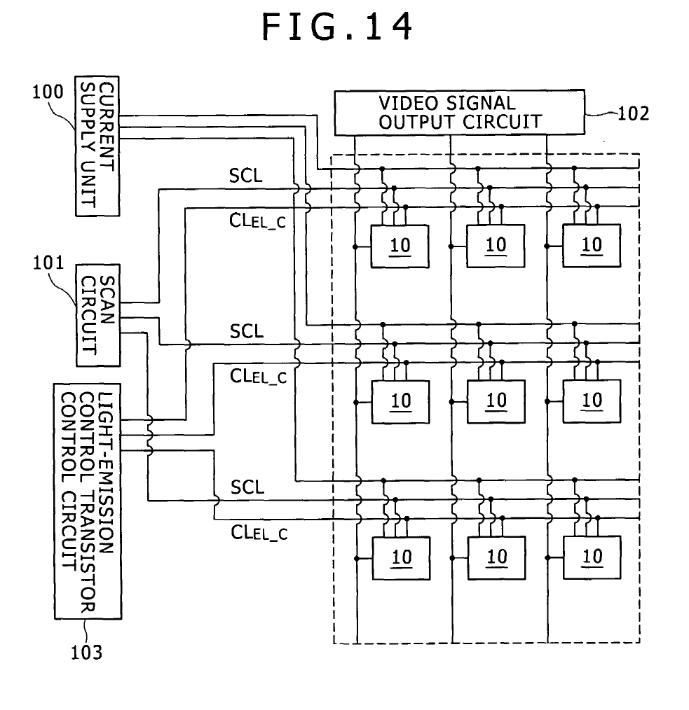

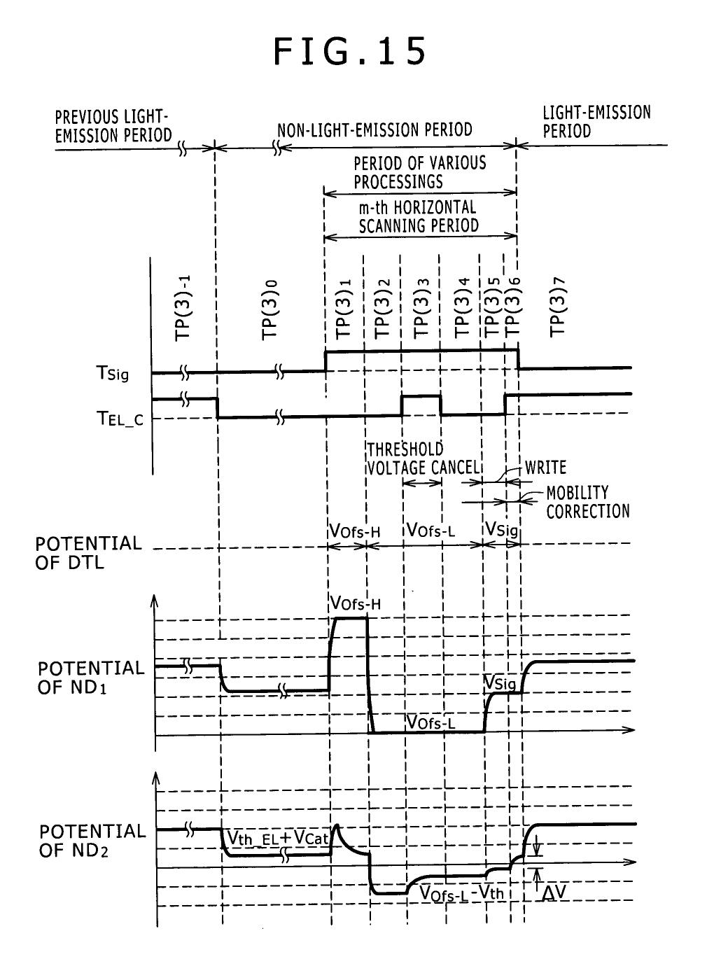

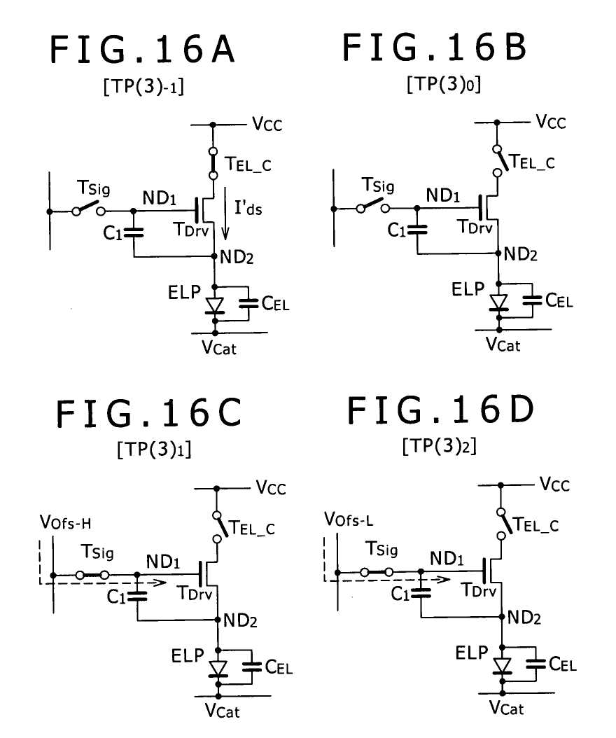

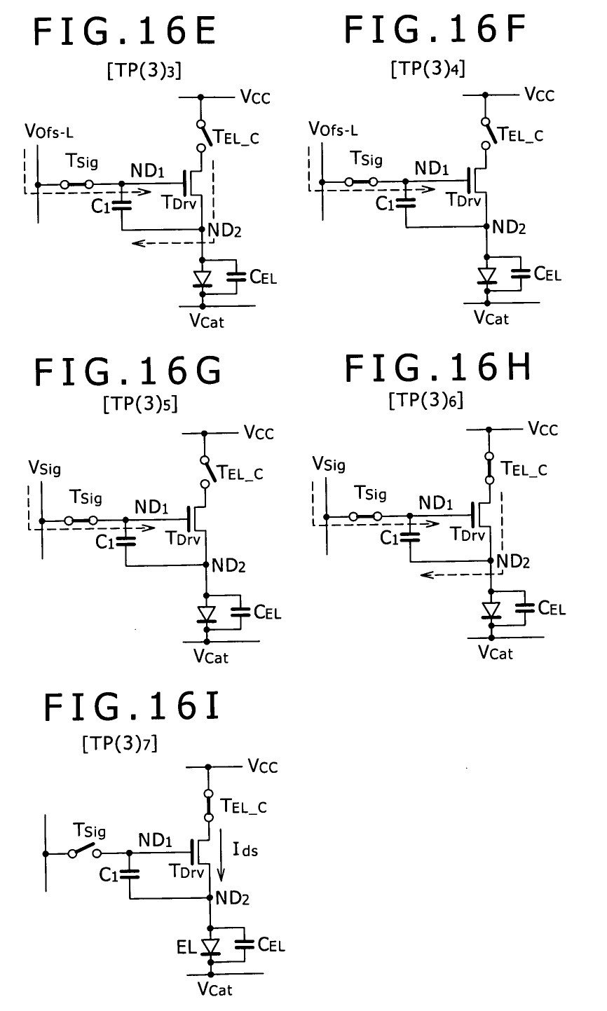

FIGS. 12 and 13 are equivalent circuit diagrams of the 3Tr/1C drive circuit. FIG. 14 is a conceptual diagram of a display including the 3Tr/1C drive circuits. FIG. 15 is a schematic timing chart showing the driving of the 3Tr/1C drive circuit. FIGS. 16A to 16I schematically show the on/off-states of the respective transistors and so on.

This 3Tr/1C drive circuit is obtained by omitting two transistors of the first-node initialization transistor T_{ND1} and the second-node initialization transistor T_{ND2} from the above-described 5Tr/1C drive circuit. Specifically, this 3Tr/1C drive circuit includes three transistors of the video signal write transistor T_{Sig}, the light-emission control transistor T_{EL}_{_{—}}_{C}, and the drive transistor T_{Drv}. Furthermore, this circuit includes one capacitor C₁.

### [Light-Emission Control Transistor T_{EL}_{_{—}}_{C}]

The configuration of the light-emission control transistor T_{EL}_{_{—}}_{C} is the same as that of the light-emission control transistor T_{EL}_{_{—}}_{C} described for the 5Tr/1C drive circuit, and therefore, the detailed description thereof is omitted.

### [Drive Transistor T_{Drv}]

The configuration of the drive transistor T_{Drv} is the same as that of the drive transistor T_{Drv} described for the 5Tr/1C drive circuit, and therefore, the detailed description thereof is omitted.

### [Video Signal Write Transistor T_{Sig}]

The configuration of the video signal write transistor T_{Sig} is the same as that of the video signal write transistor T_{Sig} described for the 5Tr/1C drive circuit, and therefore, the detailed description thereof is omitted. However, to one source/drain region of the video signal write transistor T_{Sig}, which is connected to the data line DTL, not only the drive signal (luminance signal) V_{Sig} for controlling the luminance of the light-emitting part ELP but also voltages V_{Ofs-H} and V_{Ofs-L}, for initializing the gate electrode of the drive transistor T_{Drv}, are supplied from the video signal output circuit 102. This feature is different from the operation of the video signal write transistor T_{Sig} described for the 5Tr/1C drive circuit. Signals and voltages other than V_{Sig} and V_{Ofs-H}/V_{Ofs-L} (e.g. a signal for precharge driving) may be supplied from the video signal output circuit 102 via the data line DTL to one source/drain region. Examples of the values of the voltages V_{Ofs-H} and V_{Ofs-L} are, but not limited to, the following values.

V_{Ofs-H}=about 30 volts

V_{Ofs-L}=about 0 volt

### [Relationship Between Capacitances of C_{EL} and C₁]

As described later, in the 3Tr/1C drive circuit, the potential of the second node ND₂ is changed by using the data line DTL. For the above-described 5Tr/1C drive circuit and 4Tr/1C drive circuit, the explanation has been made without taking into consideration the change of the potential of the source region of the drive transistor T_{Drv} (second node ND₂) based on the change (V_{Sig}−V_{Ofs}) of the potential of the gate electrode of the drive transistor T_{Drv}, based on the assumption that the capacitance c_{EL} (and the capacitance c_{Sub} of the auxiliary capacitor C_{Sub}, in the case of a drive circuit connected to the auxiliary capacitor C_{Sub}) is sufficiently higher than the capacitance c₁ and the capacitance c_{gs}. In contrast, in the 3Tr/1C drive circuit, the capacitance c₁ is set higher than that in the other drive circuits in design (for example, the capacitance c₁ is set to about ¼ to ⅓ of the capacitance c_{EL}, and in the case of a drive circuit connected to the auxiliary capacitor C_{Sub}, the total value of the capacitance c_{sub} of the auxiliary capacitor C_{Sub} and the capacitance c₁ is set to about ¼ to ⅓ of the capacitance c_{EL}). Accordingly, compared with the other drive circuits, the potential change of the second node ND₂ arising due to the potential change of the first node ND₁ is larger. Therefore, in the description of the 3Tr/1C drive circuit, the potential change of the second node ND₂ arising due to the potential change of the first node ND₁ is taken into consideration. The driving timing chart of FIG. 15 is also shown in consideration of the potential change of the second node ND₂ arising due to the potential change of the first node ND₁.

### [Light-Emitting Part ELP]

The configuration of the light-emitting part ELP is the same as that of the light-emitting part ELP described for the 5Tr/1C drive circuit, and therefore, the detailed description thereof is omitted.

The operation of the 3Tr/1C drive circuit will be described below.

### [Period-TP(3)₋₁] (See FIG. 16A)

[period-TP(3)₋₁] corresponds to the operation in the previous display frame, for example. In this period, substantially the same operation as that in [period-TP(5)₋₁], described for the 5Tr/1C drive circuit, is carried out.

The period from [period-TP(3)₀] to [period-TP(3)₄] shown in FIG. 15 is equivalent to the period from [period-TP(5)₀] to [period-TP(5)₄] shown in FIG. 5, and is the operation period until the timing immediately before the start of the next write processing. Furthermore, in this period from [period-TP(3)₀] to [period-TP(3)₄], the (n, m)-th organic EL element 10 is in the non-light-emission state, similar to the 5Tr/1C drive circuit. However, the operation of the 3Tr/1C drive circuit is different from the operation of the 5Tr/1C drive circuit, in that the period from [period-TP(3)₁] to [period-TP(3)₄] in addition to the period from [period-TP(3)₅] to [period-TP(3)₆] is included in the m-th horizontal scanning period, as shown in FIG. 15. For convenience of explanation, the following description is based on the assumption that the start timing of [period-TP(3)₁] and the end timing of [period-TP(3)₆] correspond with the start timing and end timing of the m-th horizontal scanning period, respectively.

The respective periods of [period-TP(3)₀] to [period-TP(3)₄] will be described below. Similar to the 5Tr/1C drive circuit, the lengths of the respective periods of [period-TP(3)₁] to [period-TP(3)₄] are properly defined depending on the design of the organic EL display.

### [Period-TP(3)₀] (See FIG. 16B)

[period-TP(3)₀] corresponds to the operation for the transition from the previous display frame to the current display frame, for example. In this period, substantially the same operation as that in [period-TP(5)₀] described for the 5Tr/1C drive circuit is carried out.

### [Period-TP(3)₁] (See FIG. 16C)

The m-th horizontal scanning period in the current display frame starts. At the start of [period-TP(3)₁], the potential of the data line DTL is set to the voltage V_{Ofs-H} for initializing the gate electrode of the drive transistor T_{Drv} based on the operation of the video signal output circuit 102. Subsequently, the video signal write transistor T_{Sig} is turned to the on-state by switching the scan line SCL to the high level based on the operation of the scan circuit 101. As a result, the potential of the first node ND₁ becomes V_{Ofs-H}. Because the capacitance c₁ of the capacitor C₁ is set higher than that in the other drive circuits in design, as described above, the potential of the source region (the potential of the second node ND₂) rises. As a result, the potential difference between both ends of the light-emitting part ELP surpasses the threshold voltage V_{th-EL}, and thus the light-emitting part ELP enters the conductive state. However, the potential of the source region of the drive transistor T_{Drv} immediately decreases to (V_{th-EL}+V_{Cat}) again. In this process, the light-emitting part ELP possibly emits light. However, this light emission is instantaneous and hence results in no problem in practical use. On the other hand, the potential of the gate electrode of the drive transistor T_{Drv} is kept at the voltage V_{Ofs-H}.

### [Period-TP(3)₂] (See FIG. 16D)

Based on the operation of the video signal output circuit 102, the potential of the data line DTL is changed from the voltage V_{Ofs-H} for initializing the gate electrode of the drive transistor T_{Drv} to the voltage V_{Ofs-L}. This changes the potential of the first node ND₁ to V_{Ofs-L}. In linkage with the potential decrease of the first node ND₁, the potential of the second node ND₂ also decreases. Specifically, charges based on the change (V_{Ofs-L}−V_{Ofs-H}) of the potential of the gate electrode of the drive transistor T_{Drv} are distributed into the capacitor C₁, the parasitic capacitor C_{EL} of the light-emitting part ELP, the auxiliary capacitor C_{Sub} (in the case of a drive circuit connected to the auxiliary capacitor C_{Sub}), and the parasitic capacitor between the gate electrode and source region of the drive transistor T_{Drv}. As the premise of the operation in [period-TP(3)₃] to be described later, the potential of the second node ND₂ should be lower than V_{Ofs-L}−Vₜₕ at the end timing of [period-TP(3)₂]. The values of V_{Ofs-H} and so on are so designed as to satisfy this condition. That is, due to the above-described processing, the potential difference between the gate electrode and source region of the drive transistor T_{Drv} becomes equal to or larger than Vₜₕ, so that the drive transistor T_{Drv} enters the on-state.

### [Period-TP(3)₃] (See FIG. 16E)

Subsequently, the threshold voltage cancel processing is executed. Specifically, with the video signal write transistor T_{Sig} kept at the on-state, the light-emission control transistor T_{EL}_{_{—}}_{C} is turned to the on-state by switching the light-emission control transistor control line CL_{EL}_{_{—}}_{C} to the high level based on the operation of the light-emission control transistor control circuit 103. As a result, the potential of the second node ND₂ in the floating state rises up whereas the potential of the first node ND₁ does not change (but is kept at V_{Ofs-L}=0 volt), so that the potential difference between the first node ND₁ and the second node ND₂ approaches the threshold voltage Vₜₕ of the drive transistor T_{Drv}. When the potential difference between the gate electrode and source region of the drive transistor T_{Drv} has reached Vₜₕ, the drive transistor T_{Drv} is turned to the off-state. Specifically, the potential of the second node ND₂ in the floating state approaches (V_{Ofs-L}−Vₜₕ=−3 volts), and eventually becomes (V_{Ofs-L}−Vₜₕ). At this time, the light-emitting part ELP does not emit light as long as the above-described Inequality (2) is assured, in other words, as long as the potentials are so selected and determined as to satisfy Inequality (2).

In [period-TP(3)₃], the potential of the second node ND₂ eventually becomes (V_{Ofs-L}−Vₜₕ), for example. Specifically, the potential of the second node ND₂ is determined depending only on the threshold voltage Vₜₕ of the drive transistor T_{Drv} and the voltage V_{Ofs-L} for initializing the gate electrode of the drive transistor T_{Drv}. Furthermore, the potential is irrespective of the threshold voltage V_{th-EL} of the light-emitting part ELP.

### [Period-TP(3)₄] (See FIG. 16F)

With the video signal write transistor T_{Sig} kept at the on-state, the light-emission control transistor T_{EL}_{_{—}}_{C} is turned to the off-state by switching the light-emission control transistor control line CL_{EL}_{_{—}}_{C} to the low level based on the operation of the light-emission control transistor control circuit 103. As a result, the potential of the first node ND₁ is not changed (but kept at V_{Ofs-L}=0 volt), and the potential of the second node ND₂ in the floating state is also not changed but kept at (V_{Ofs-L}−Vₜₕ=−3 volts).

The respective periods of [period-TP(3)₅] to [period-TP(3)₇] will be described below. In these periods, substantially the same operations as those in the periods of [period-TP(5)₅] to [period-TP(5)₇] described for the 5Tr/1C drive circuit are carried out.

### [Period-TP(3)₅] (See FIG. 16G)

The write processing for the drive transistor T_{Drv} is executed. Specifically, in the state in which the video signal write transistor T_{Sig} is kept at the on-state, whereas the light-emission control transistor T_{EL}_{_{—}}_{C} is kept at the off-state, the potential of the data line DTL is set to the drive signal (luminance signal) V_{Sig} for controlling the luminance of the light-emitting part ELP, based on the operation of the video signal output circuit 102. As a result, the potential of the first node ND₁ rises to V_{Sig}. The following procedure is also available for the write processing. Specifically, after the video signal write transistor T_{Sig} is temporarily turned to the off-state, in the state in which the video signal write transistor T_{Sig} and the light-emission control transistor T_{EL}_{_{—}}_{C} are kept at the off-state, the potential of the data line DTL is changed to the drive signal (luminance signal) V_{Sig} for controlling the luminance of the light-emitting part ELP. Thereafter, with the light-emission control transistor T_{EL}_{_{—}}_{C} kept at the off-state, the video signal write transistor T_{Sig} is turned to the on-state by switching the scan line SCL to the high level.

In [period-TP(3)₅], the potential of the first node ND₁ rises up from V_{Ofs-L} to V_{Sig}. Thus, in view of the potential change of the second node ND₂ arising due to the potential change of the first node ND₁, the potential of the second node ND₂ also rises slightly. Specifically, the resulting potential of the second node ND₂ can be represented as V_{Ofs-L}−Vₜₕ+α·(V_{Sig}−V_{Ofs-L}). α satisfies the inequality 0<α<1 and is defined depending on the capacitances of the capacitor C₁, the parasitic capacitor C_{EL} of the light-emitting part ELP (and the auxiliary capacitor C_{Sub}, in the case of a drive circuit connected to the auxiliary capacitor C_{Sub}), and so on.

Due to the write processing, similar to the 5Tr/1C drive circuit, the value described with Equation (3′) shown below can be obtained as the potential difference between the first node ND₁ and the second node ND₂, i.e., the potential difference V_{gs} between the gate electrode and source region of the drive transistor T_{Drv}.

V_{gs}≈V_{Sig}−(V_{Ofs-L}−Vₜₕ)−α·(V_{Sig}−V_{Ofs-L}) (3′)

Specifically, also in the 3Tr/1C drive circuit, the potential difference V_{gs} resulting from the write processing for the drive transistor T_{Drv} depends only on the drive signal (luminance signal) V_{Sig} for controlling the luminance of the light-emitting part ELP, the threshold voltage Vₜₕ of the drive transistor T_{Drv}, and the voltage V_{Ofs-L} for initializing the gate electrode of the drive transistor T_{Drv}. Furthermore, the potential difference V_{gs} is irrespective of the threshold voltage V_{th-EL} of the light-emitting part ELP.

### [Period-TP(3)₆] (See FIG. 16H)

Correction of the potential of the source region of the drive transistor T_{Drv} (second node ND₂) based on the magnitude of the mobility μ of the drive transistor T_{Drv} (mobility correction processing) is carried out. Specifically, the same operation as that in [period-TP(5)₆] described for the 5Tr/1C drive circuit is carried out. The predetermined time (the total time to of [period-TP(3)₆]) for executing the mobility correction processing is determined as a design value in advance at the time of the designing of the organic EL display.

### [Period-TP(3)₇] (See FIG. 16I)

Through the above-described operation, the threshold voltage cancel processing, the write processing, and the mobility correction processing are completed. Subsequently, the same processing as that in [period-TP(5)₇] described for the 5Tr/1C drive circuit is executed, so that the potential of the second node ND₂ rises up and surpasses (V_{th-EL}+V_{Cat}). Thus, the light-emitting part ELP starts light emission. The value of the current that flows through the light-emitting part ELP at this time can be obtained from the above-described Equation (5). Therefore, the current I_{ds} that flows through the light-emitting part ELP does not depend on the threshold voltage V_{th-EL} of the light-emitting part ELP and the threshold voltage Vₜₕ of the drive transistor T_{Drv}. That is, the light-emission amount (luminance) of the light-emitting part ELP is not affected by the threshold voltage V_{th-EL} of the light-emitting part ELP and the threshold voltage Vₜₕ of the drive transistor T_{Drv}. In addition, the occurrence of variation in the drain current I_{ds} attributed to variation in the mobility μ of the drive transistor T_{Drv} can be suppressed.

The light-emission state of the light-emitting part ELP is continued until the end of the (m+m′−1)-th horizontal scanning period. This timing is equivalent to the end of [period-TP(3)₋₁].

Through the above-described steps, the light-emission operation of the organic EL element 10 (the (n, m)-th sub-pixel (organic EL element 10)) is completed.

The 2Tr/1C drive circuit will be described below.

### [2Tr/1C Drive Circuit]

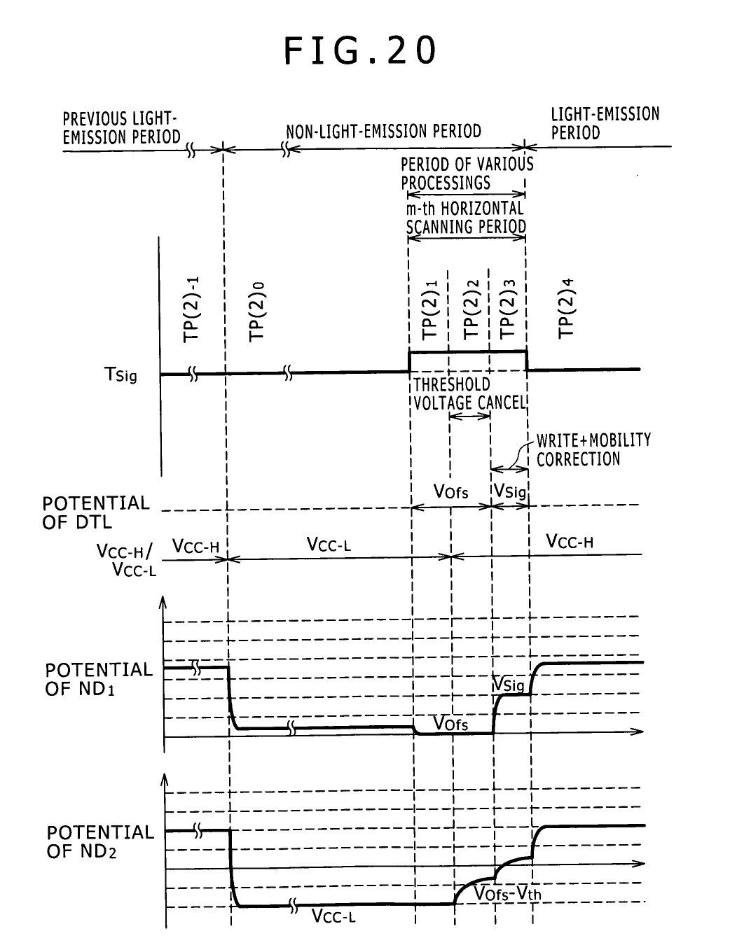

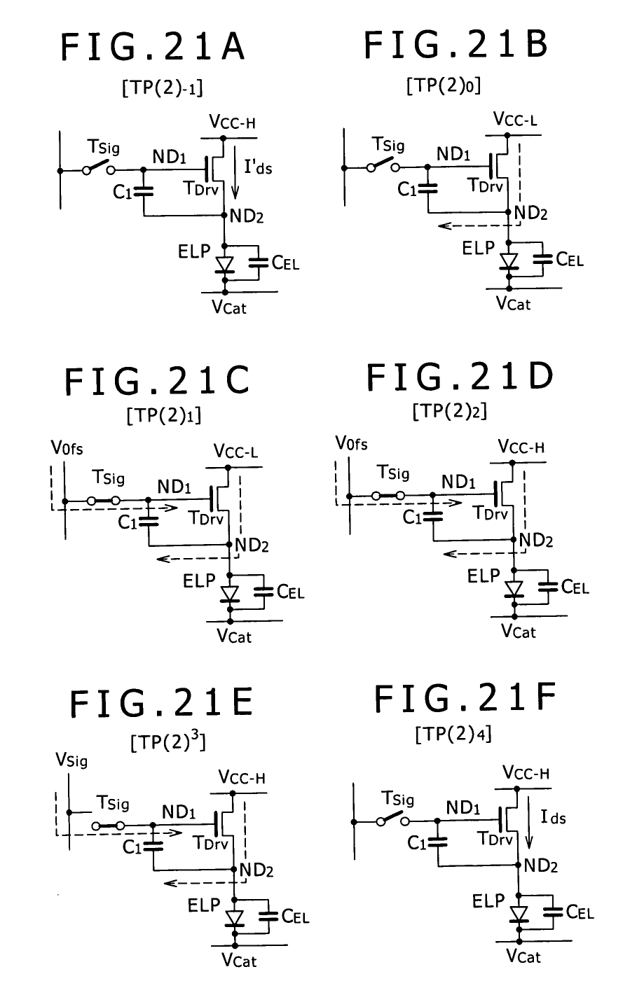

FIGS. 17 and 18 are equivalent circuit diagrams of the 2Tr/1C drive circuit. FIG. 19 is a conceptual diagram of a display including the 2Tr/1C drive circuits. FIG. 20 is a schematic timing chart showing the driving of the 2Tr/1C drive circuit. FIGS. 21A to 21F schematically show the on/off-states of the respective transistors and so on.

This 2Tr/1C drive circuit is obtained by omitting three transistors of the first-node initialization transistor T_{ND1}, the light-emission control transistor T_{EL}_{_{—}}_{C}, and the second-node initialization transistor T_{ND2} from the above-described 5Tr/1C drive circuit. Specifically, this 2Tr/1C drive circuit includes two transistors of the video signal write transistor T_{Sig} and the drive transistor T_{Drv}. Furthermore, this circuit includes one capacitor C₁.

### [Drive Transistor T_{Drv}]

The configuration of the drive transistor T_{Drv} is the same as that of the drive transistor T_{Drv} described for the 5Tr/1C drive circuit, and therefore, the detailed description thereof is omitted. However, the drain region of the drive transistor T_{Drv} is connected to the current supply unit 100. From the current supply unit 100, a voltage V_{CC-H} for controlling the light emission of the light-emitting part ELP and a voltage V_{CC-L} for controlling the potential of the source region of the drive transistor T_{Drv} are supplied. Examples of the values of the voltages V_{CC-H} and V_{CC-L} are as follows.

V_{CC-H}=20 volts

V_{CC-L}=−10 volts

However, the voltage values are not limited thereto.

### [Video Signal Write Transistor T_{Sig}]

The configuration of the video signal write transistor T_{Sig} is the same as that of the video signal write transistor T_{Sig} described for the 5Tr/1C drive circuit, and therefore, the detailed description thereof is omitted.

### [Light-Emitting Part ELP]

The configuration of the light-emitting part ELP is the same as that of the light-emitting part ELP described for the 5Tr/1C drive circuit, and therefore, the detailed description thereof is omitted.

The operation of the 2Tr/1C drive circuit will be described below.

### [Period-TP(2)₋₁] (See FIG. 21A)

[period-TP(2)₋₁] corresponds to the operation in the previous display frame, for example. In this period, substantially the same operation as that in [period-TP(5)₋₁] described for the 5Tr/1C drive circuit is carried out.

The period from [period-TP(2)₀] to [period-TP(2)₂] shown in FIG. 20 is equivalent to the period from [period-TP(5)₀] to [period-TP(5)₄] shown in FIG. 5, and is the operation period until the timing immediately before the start of the next write processing. Furthermore, in this period from [period-TP(2)₀] to [period-TP(2)₂], the (n, m)-th organic EL element 10 is in the non-light-emission state, similar to the 5Tr/1C drive circuit. However, the operation of the 2Tr/1C drive circuit is different from the operation of the 5Tr/1C drive circuit, in that the period from [period-TP(2)₁] to [period-TP(2)₂] in addition to [period-TP(2)₃] is included in the m-th horizontal scanning period as shown in FIG. 20. For convenience of explanation, the following description is based on the assumption that the start timing of [period-TP(2)₁] and the end timing of [period-TP(2)₃] correspond with the start timing and end timing of the m-th horizontal scanning period, respectively.

The respective periods of [period-TP(2)₀] to [period-TP(2)₂] will be described below. Similar to the 5Tr/1C drive circuit, the lengths of the respective periods of [period-TP(2)₁] to [period-TP(2)₃] are properly defined depending on the design of the organic EL display.

### [Period-TP(2)₀] (See FIG. 21B)

[period-TP(2)₀] corresponds to the operation for the transition from the previous display frame to the current display frame, for example. Specifically, this [period-TP(2)₀] is the period from the start of the (m+m′)-th horizontal scanning period in the previous display frame to the end of the (m−1)-th horizontal scanning period in the current display frame. In [period-TP(2)₀], the (n, m)-th organic EL element 10 is in the non-light-emission state. At the timing of the transition from [period-TP(2)₋₁] to [period-TP(2)₀], the voltage supplied from the current supply unit 100 is switched from V_{CC-H} to V_{CC-L}. As a result, the potential of the second node ND₂ (the source region of the drive transistor T_{Drv} and the anode electrode of the light-emitting part ELP) decreases to V_{CC-L}, so that the light-emitting part ELP enters the non-light-emission state. Furthermore, the potential of the first node ND₁ (the gate electrode of the drive transistor T_{Drv}) in the floating state also decreases in such a manner as to follow the potential decrease of the second node ND₂.

### [Period-TP(2)₁] (See FIG. 21C)

The m-th horizontal scanning period in the current display frame starts. At the start of [period-TP(2)₁], the video signal write transistor T_{Sig} is turned to the on-state by switching the scan line SCL to the high level based on the operation of the scan line 101. As a result, the potential of the first node ND₁ becomes V_{Ofs} (e.g. 0 volt). The potential of the second node ND₂ is kept at V_{CC-L} (e.g. −10 volts).

Due to the above-described processing, the potential difference between the gate electrode and source region of the drive transistor T_{Drv} becomes equal to or larger than Vₜₕ, so that the drive transistor T_{Drv} enters the on-state.

### [Period-TP(2)₂] (See FIG. 21D)

Subsequently, the threshold voltage cancel processing is executed. Specifically, the voltage supplied from the current supply unit 100 is switched from V_{CC-L} to V_{CC-H}, with the video signal write transistor T_{Sig} kept at the on-state. As a result, the potential of the second node ND₂ in the floating state rises up whereas the potential of the first node ND₁ does not change (but is kept at V_{Ofs}=0 volt), so that the potential difference between the first node and the second node approaches the threshold voltage of the drive transistor. When the potential difference between the gate electrode and source region of the drive transistor T_{Drv} has reached Vₜₕ, the drive transistor T_{Drv} is turned to the off-state. Specifically, the potential of the second node ND₂ in the floating state approaches (V_{Ofs}−Vₜₕ=−3 volts), and eventually becomes (V_{Ofs}−Vₜₕ). At this time, the light-emitting part ELP does not emit light as long as the above-described Inequality (2) is assured, in other words, as long as the potentials are so selected and determined as to satisfy Inequality (2).

In [period-TP(2)₂], the potential of the second node ND₂ eventually becomes (V_{Ofs}−Vₜₕ), for example. Specifically, the potential of the second node ND₂ is determined depending only on the threshold voltage Vₜₕ of the drive transistor T_{Drv} and the voltage V_{Ofs} for initializing the gate electrode of the drive transistor T_{Drv}. Furthermore, the potential is irrespective of the threshold voltage V_{th-EL} of the light-emitting part ELP.

### [Period-TP(2)₃] (See FIG. 21E)

Write processing for the drive transistor T_{Drv} and correction of the potential of the source region of the drive transistor T_{Drv} (second node ND₂) based on the magnitude of the mobility μ of the drive transistor T_{Drv} (mobility correction processing) are carried out. Specifically, with the video signal write transistor T_{Sig} kept at the on-state, the potential of the data line DTL is set to the drive signal (luminance signal) V_{Sig} for controlling the luminance of the light-emitting part ELP, based on the operation of the video signal output circuit 102. As a result, the potential of the first node ND₁ rises to V_{Sig}, so that the drive transistor T_{Drv} enters the on-state. Specifically, after the video signal write transistor T_{Sig} is temporarily turned to the off-state, the potential of the data line DTL is changed to the drive signal (luminance signal) V_{Sig} for controlling the luminance of the light-emitting part ELP. Thereafter, the video signal write transistor T_{Sig} is turned to the on-state by switching the scan line SCL to the high level, to thereby turn the drive transistor T_{Drv} to the on-state.

Unlike the 5Tr/1C drive circuit, the potential of the source region of the drive transistor T_{Drv} rises up because the potential V_{CC-H} is applied from the current supply unit 100 to the drain region of the drive transistor T_{Drv}. After the elapse of a predetermined time (t₀), the video signal write transistor T_{Sig} is turned to the off-state by switching the scan line SCL to the low level, to thereby turn the first node ND₁ (the gate electrode of the drive transistor T_{Drv}) to the floating state. At the time of the designing of the organic EL display, the total time to of [period-TP(2)₃] is so determined as a design value in advance that the potential of the second node ND₂ will become (V_{Ofs}−Vₜₕ+ΔV) as a result of the operation in [period-TP(2)₃].

Also in [period-TP(2)₃], when the mobility μ of the drive transistor T_{Drv} is high, the rise amount ΔV of the potential of the source region of the drive transistor T_{Drv} is large. In contrast, when the mobility μ of the drive transistor T_{Drv} is low, the rise amount ΔV of the potential of the source region of the drive transistor T_{Drv} is small.

### [Period-TP(2)₄] (See FIG. 21F)

Through the above-described operation, the threshold voltage cancel processing, the write processing, and the mobility correction processing are completed. Subsequently, the same processing as that in [period-TP(5)₇] described for the 5Tr/1C drive circuit is executed, so that the potential of the second node ND₂ rises up and surpasses (V_{th-EL}+V_{Cat}). Thus, the light-emitting part ELP starts light emission. The value of the current that flows through the light-emitting part ELP at this time can be obtained from the above-described Equation (5). Therefore, the current I_{ds} that flows through the light-emitting part ELP does not depend on the threshold voltage V_{th-EL} of the light-emitting part ELP and the threshold voltage Vₜₕ of the drive transistor T_{Drv}. That is, the light-emission amount (luminance) of the light-emitting part ELP is not affected by the threshold voltage V_{th-EL} of the light-emitting part ELP and the threshold voltage Vₜₕ of the drive transistor T_{Drv}. In addition, the occurrence of variation in the drain current I_{ds} attributed to variation in the mobility μ of the drive transistor T_{Drv} can be suppressed.

The light-emission state of the light-emitting part ELP is continued until the end of the (m+m′−1)-th horizontal scanning period. This timing is equivalent to the end of [period-TP(2)₋₁].

Through the above-described steps, the light-emission operation of the organic EL element 10 (the (n, m)-th sub-pixel (organic EL element 10)) is completed.

This is the end of the description of preferred embodiments of the present invention. The invention however is not limited to these embodiments. The configurations and structures of the various components of the organic EL displays described for the embodiments are merely examples and can be arbitrarily changed.

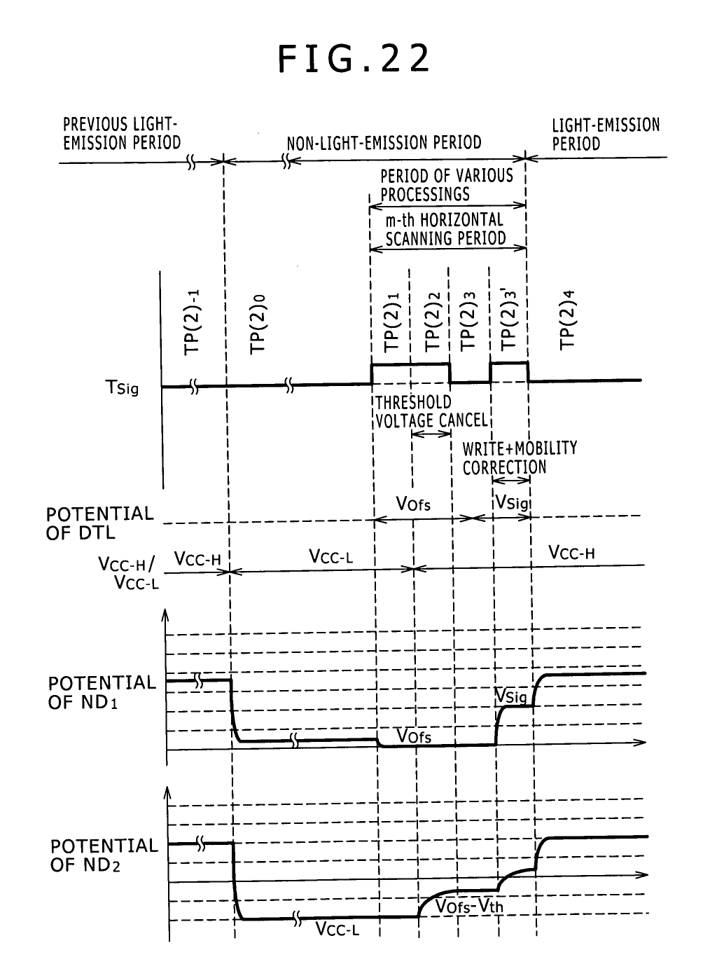

For example, the operation of the 2Tr/1C drive circuit may be modified as follows. Specifically, [period-TP(2)₃] is divided into two periods of [period-TP(2)₃] and [period-TP(2)₃]. In [period-TP(2)₃], as described above, after the video signal write transistor T_{Sig} is temporarily turned to the off-state, the potential of the data line DTL is changed to the drive signal (luminance signal) V_{Sig} for controlling the luminance of the light-emitting part ELP. Thereafter, in [period-TP(2)′₃], the video signal write transistor T_{Sig} is turned to the on-state by switching the scan line SCL to the high level, to thereby turn the drive transistor T_{Drv} to the on-state. A timing chart corresponding to this modification is schematically shown in FIG. 22.

It should be understood by those skilled in the art that various modifications, combinations, sub-combinations and alterations may occur depending on design requirements and other factor in so far as they are within the scope of the appended claims or the equivalents thereof.

1. An organic electroluminescence display including a plurality of pixels, each pixel being composed of a plurality of sub-pixels, each of the sub-pixels comprising:
an organic electroluminescence element configured to have a structure arising from stacking a drive circuit and an organic electroluminescence light-emitting part connected to the drive circuit; wherein
an auxiliary capacitor connected in parallel to the organic electroluminescence light-emitting part of the drive circuit is connected to the drive circuit of one sub-pixel of the plurality of sub-pixels included in one pixel, and
the auxiliary capacitor is provided in the same plane as that of the drive circuit.

2. The organic electroluminescence display according to claim 1, wherein
in the plurality of sub-pixels included in one pixel, sizes of the drive circuits of the plurality of sub-pixels are identical to each other.

3. The organic electroluminescence display according to claim 1, wherein
the drive circuit includes:
(A) a drive transistor having source/drain regions, a channel forming region, and a gate electrode;
(B) a video signal write transistor having source/drain regions, a channel forming region, and a gate electrode; and
(C) a capacitor having a pair of electrodes;
regarding the drive transistor,
(A-1) one source/drain region of the drive transistor is connected to a current supply unit,
(A-2) the other source/drain region of the drive transistor is connected to an anode electrode of the organic electroluminescence light-emitting part and one electrode of the capacitor, and is equivalent to a second node, and
(A-3) the gate electrode of the drive transistor is connected to the other source/drain region of the video signal write transistor and the other electrode of the capacitor, and is equivalent to a first node,
regarding the video signal write transistor,
(B-1) one source/drain region of the video signal write transistor is connected to a data line, and
(B-2) the gate electrode of the video signal write transistor is connected to a scan line.

4. An organic electroluminescence display including a plurality of pixels, each pixel being composed of a plurality of sub-pixels, each of the sub-pixels comprising:
an organic electroluminescence element configured to have a structure arising from stacking a drive circuit and an organic electroluminescence light-emitting part connected to the drive circuit; wherein
in the plurality of sub-pixels included in one pixel, a size of one drive circuit of the drive circuits of the plurality of sub-pixels is larger than sizes of the other drive circuits, and
the one drive circuit is provided with an auxiliary capacitor connected in parallel to the organic electroluminescence light-emitting part of the drive circuit.

5. The organic electroluminescence display according to claim 4, wherein
the drive circuit includes:
(A) a drive transistor having source/drain regions, a channel forming region, and a gate electrode;
(B) a video signal write transistor having source/drain regions, a channel forming region, and a gate electrode; and
(C) a capacitor having a pair of electrodes;
regarding the drive transistor,
(A-1) one source/drain region of the drive transistor is connected to a current supply unit,
(A-2) the other source/drain region of the drive transistor is connected to an anode electrode of the organic electroluminescence light-emitting part and one electrode of the capacitor, and is equivalent to a second node, and
(A-3) the gate electrode of the drive transistor is connected to the other source/drain region of the video signal write transistor and the other electrode of the capacitor, and is equivalent to a first node,
regarding the video signal write transistor,
(B-1) one source/drain region of the video signal write transistor is connected to a data line, and
(B-2) the gate electrode of the video signal write transistor is connected to a scan line.
